(19) United States
(12) Patent Application Publication
(10) Pub. No.: US 2003/0041167 A1
(43) Pub. Date: Feb. 27, 2003

(54) Method and system for managing secure geographic boundary resources within a network management framework

(75) Inventors: Steven French, Austin, TX (US); Lorin Evan Ullmann, Austin, TX (US); Cristi Nesbitt Ullmann, Austin, TX (US)

Correspondence Address: Joseph R. Burwell, Law Office of Joseph R. Burwell, P.O. Box 28022, Austin, TX, 78755-8022, US

(73) Assignee: INTERNATIONAL BUSINESS MACHINES CORPORATION, ARMONK, NY (US)

(21) Appl. No.: 09/930,424

(22) Filed: Aug. 15, 2001

(51) Int. Cl. G06F 15/173

(52) U.S. Cl. 709/238; 709/225

(57) ABSTRACT

A method, system, apparatus, and computer program product is presented for management of a distributed data processing system on behalf of a plurality of management customers. Endpoint objects, system objects, and network objects are logically organized into a set of scopes that do not logically overlap. An administrative user may dynamically reconfigure logical networks within the distributed data processing system while managing the logical networks for a set of customers. The network management system is able to provide security at logical boundaries between networks. Geographic location identifiers are associated with network resources. Network-related actions can be performed on resources with common geographic boundaries. The network management framework assists administrators in opening or closing access to resources/devices at the boundaries such that portions of a highly distributed data processing system could be quarantined from other portions of the distributed data processing system.

### BACKGROUND OF THE INVENTION

1. Field of the Invention

The present invention relates to an improved data processing system and, in particular, to a method and system for multiple computer or process coordinating. Still more particularly, the present invention provides a method and system for network management.

2. Description of Related Art

Technology expenditures have become a significant portion of operating costs for most enterprises, and businesses are constantly seeking ways to reduce information technology (IT) costs. This has given rise to an increasing number of outsourcing service providers, each promising, often contractually, to deliver reliable service while offloading the costly burdens of staffing, procuring, and maintaining an IT organization. While most service providers started as network pipe providers, they are moving into server outsourcing, application hosting,,and desktop management. For those enterprises that do not outsource, they are demanding more accountability from their IT organizations as well as demanding that IT is integrated into their business goals. In both cases, “service level agreements” have been employed to contractually guarantee service delivery between an IT organization and its customers. As a result, IT teams now require management solutions that focus on and support “business processes” and “service delivery” rather than just disk space monitoring and network pings.

IT solutions now require end-to-end management that includes network connectivity, server maintenance, and application management in order to succeed. The focus of IT organizations has turned to ensuring overall service delivery and not just the “towers” of network, server, desktop, and application. Management systems must fulfill two broad goals: a flexible approach that allows rapid deployment and configuration of new services for the customer; and an ability to support rapid delivery of the management tools themselves. A successful management solution fits into a heterogeneous environment, provides openness with which it can knit together management tools and other types of applications, and a consistent approach to managing all of the IT assets.

With all of these requirements, a successful management approach will also require attention to the needs of the staff within the IT organization to accomplish these goals: the ability of an IT team to deploy an appropriate set of management tasks to match the delegated responsibilities of the IT staff; the ability of an IT team to navigate the relationships and effects of all of their technology assets, including networks, middleware, and applications; the ability of an IT team to define their roles and responsibilities consistently and securely across the various management tasks; the ability of an IT team to define groups of customers and their services consistently across the various management tasks; and the ability of an IT team to address, partition, and reach consistently the managed devices.

Many service providers have stated the need to be able to scale their capabilities to manage millions of devices. When one considers the number of customers in a home consumer network as well as pervasive devices, such as smart mobile phones, these numbers are quickly realized. Significant bottlenecks appear when typical IT solutions attempt to support more than several thousand devices.

Given such network spaces, a management system must be very resistant to failure so that service attributes, such as response time, uptime, and throughput, are delivered in accordance with guarantees in a service level agreement. In addition, a service provider may attempt to support many customers within a single network management system. The service provider's profit margins may materialize from the ability to bill usage of a common management system to multiple customers.

On the other hand, the service provider must be able to support contractual agreements on an individual basis. Service attributes, such as response time, uptime, and throughput, must be determinable for each customer. In order to do so, a network management system must provide a suite of network management tools that is able to perform device monitoring and discovery for each customer's network while integrating these abilities across a shared network backbone to gather the network management information into the service provider's distributed data processing system. There is a direct relationship between the ability of a management system to provide network monitoring and discovery functionality and the ability of a service provider using the management system to serve multiple customers using a single management system. Preferably, the management system can replicate services, detect faults within a service, restart services, and reassign work to a replicated service. By implementing a common set of interfaces across all of their services, each service developer gains the benefits of system robustness. A well-designed, component-oriented, highly distributed system can easily accept a variety of services on a common infrastructure with built-in fault-tolerance and levels of service.

As with most organizations, an IT organization, such as a service provider, may classify its personnel into different managerial roles. Given a scenario in which a service provider is using an integrated network management system for multiple customers, it is most likely that many individuals will be assigned to manage different customers, different regions, and different groups of devices. In addition, separate individuals may have different duties within the same or similar portions of the network, such as deploying new devices versus monitoring the uptime of those devices, and the management system should be able to differentiate the roles of the individuals and to restrict the actions of any particular individual to those operations that are appropriate for the individual's role.

In a typical network management system of possibly thousands of devices, the system may contain a security context for the network administrator, for example, by assigning a specific class of privileges to the administrator based on the administrator's group. Within a runtime environment, the administrator can attempt to perform certain administrative functions that are not allowed to be performed by the average user. For example, a particular administrator may be responsible for maintaining a particular subnet of devices with a range of IP addresses between X.Y.Z.0 and X.Y.Z.255. At some point, the administrator may log into the management system and attempt to manage a device at address X.Y.Z.5. The network management system must determine whether to allow the administrator to perform the management function on that particular device.

In some systems, the authorization process occurs solely at the time of the login operation. If the administrator has been authenticated and is authorized to use a particular application, then the system allows the application to perform all of its actions without further authorization checks. With this type of system, however, it is difficult to achieve the granularity of control that is necessary for a service provider with multiple customers within a highly distributed system in which different sets of administrators have responsibility for different customers.

Moreover, prior art network management systems do not allow a mixture of mobile devices and non-mobile devices within a highly distributed system to be managed geographically. In a highly distributed system comprising on the order of a million devices, the task of authorizing the actions of many individuals per customer, per region, per device, etc., becomes quite complex, particularly when many of those devices are able to move between regions or even between customers.

Therefore, it would be particularly advantageous to provide a method and system in a network management framework for flexibly managing the logical networks of multiple customers within a highly distributed system. It would be particularly advantageous for the network management system to provide security authorization in accordance with geographical location while allowing for dynamic changes in administrative responsibility for various networks and customers. It would also be advantageous to be able to perform certain network-related actions with respect to one or more boundaries of geographic regions.

### SUMMARY OF THE INVENTION

A method, system, apparatus, and computer program product is presented for management of a distributed data processing system on behalf of a plurality of management customers. The distributed data processing system is logically represented as a set of scopes, wherein a scope is a logical organization of network-related objects. The network-related objects may be generated by dynamically discovering endpoints, systems, and networks within the distributed data processing system, which are then correspondingly represented as a set of endpoint objects, system objects, and network objects, any of which may be labeled as a network-related object. The endpoint objects, system objects, and network objects are logically organized into a set of scopes, and each endpoint object, each system object, and each network object is uniquely assigned to a scope such that scopes do not logically overlap. Each scope is uniquely assigned to a management customer. The distributed data processing system is managed as a set of logical networks in which a logical network contains a set of scopes and in which each logical network is uniquely assigned to a management customer. An administrative user may dynamically reconfigure the logical networks within the distributed data processing system while managing the logical networks for a set of customers.

The network management system is able to provide security at logical boundaries between networks. Geographic location identifiers are associated with endpoints, systems, and networks, thereby allowing network resources to be identified based on geographic location information. Network-related actions can be performed on resources with common geographic boundaries. The present invention assists administrators in opening or closing access to resources/devices at the boundaries such that portions of a highly distributed data processing system could be quarantined from other portions of the distributed data processing system.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1 is a diagram depicting a known logical configuration of software and hardware resources;

FIG. 2A is simplified diagram illustrating a large distributed computing enterprise environment in which the present invention is implemented;

FIG. 2B is a block diagram of a preferred system management framework illustrating how the framework functionality is distributed across the gateway and its endpoints within a managed region;

FIG. 2C is a block diagram of the elements that comprise the low cost framework (LCF) client component of the system management framework;

FIG. 2D is a diagram depicting a logical configuration of software objects residing within a hardware network similar to that shown in FIG. 2A;

FIG. 2E is a diagram depicting the logical relationships between components within a system management framework that includes two endpoints and a gateway;

FIG. 2F is a diagram depicting the logical relationships between components within a system management framework that includes a gateway supporting two DKS-enabled applications;

FIG. 2G is a diagram depicting the logical relationships between components within a system management framework that includes two gateways supporting two endpoints;

FIG. 3 is a block diagram depicting components within the system management framework that provide resource leasing management functionality within a distributed computing environment such as that shown in FIGS. 2D-2E;

FIG. 4 is a block diagram showing data stored by a the IPOP (IP Object Persistence) service;

FIG. 5A is a block diagram showing the IPOP service in more detail;

FIG. 5B is a network diagram depicting a set of routers that undergo a scoping process;

FIG. 5C depicts the IP Object Security Hierarchy;

FIG. 6 is a block diagram depicting a set of components that may be used to implement scope-based security access;

FIG. 7A is a flowchart depicting a portion of an initialization process in which a network management system prepares a security subsystem for user access to network-related objects;

FIG. 7B is a flowchart depicting further detail of the initialization process in which the DSC objects are initially created and stored;

FIG. 7C is a flowchart depicting further detail of the initial DSC object creation process in which DSC objects are created and stored for an endpoint/user combination;

FIG. 7D is a flowchart depicting further detail of the initial DSC object creation process in which DSC objects are created and stored for an endpoint/endpoint combination;

FIG. 8A is a flowchart depicting a process for creating topology data;

FIG. 8B is a flowchart depicting a process for listening for physical network changes that affect topology objects;

FIG. 9A is a figure depicting a graphical user interface window that may be used by a network or system administrator to view the topology of a network that is being monitored;

FIG. 9B is a graphical user interface window that shows the topology of a network that has changed;

FIG. 10A is a block diagram depicting a known configuration of software and/or hardware network components linking multiple networks;

FIG. 10B is a block diagram depicting a service provider connected to two customers that each have subnets that may contain duplicate network addresses;

FIG. 11A is a block diagram showing a set of components that may be used to implement multi-customer management across multiple networks in which duplicate address may be present;

FIGS. 11B-11D are some simplified pseudo-code examples that depict an object-oriented manner in which action objects and endpoint objects can be implemented;

FIG. 12A is a flowchart depicting a portion of an initialization process in which a network management system prepares for managing a set of networks with multiple NATs;

FIG. 12B is a flowchart depicting further detail of the initialization process in which the administrator resolves addressability problems;

FIG. 12C is a flowchart depicting further detail of the process in which the administrator assigns VPN IDs;

FIG. 13 is a figure that depicts a graphical user interface (GUI) that may be used by a network or system administrator to set monitoring parameters for resolving address collisions;

FIG. 14A is a flowchart showing the overall process for performing an IP “Ping” with in a multi-customer, distributed data processing system containing multiple private networks; and

FIG. 14B is a flowchart that depicts a process by which an administrator chooses the source endpoint and target endpoint for the IP “Ping” action described in an overall manner in FIG. 14A;

FIG. 15 is a block diagram depicting a logical organization of network-related objects that may be managed within different scopes on behalf of multiple customers whose physical networks are being administered using the network management framework of the present invention;

FIG. 16 is a flowchart depicting a process for handling certain types of scope-related events;

FIGS. 17A-17B are flowcharts depicting a process for relocating network-related objects based on an administrator-initiated change of scope or for configuring multiple customers within a distributed data processing system;

FIG. 18 is a block diagram depicting components within the network management framework for generating and managing geographic location data associated with resources within a distributed data processing system;

FIGS. 19A-19B are a pair of flowcharts depicting a process by which the geographical location (GEOL) data is generated and associated with an endpoint;

FIG. 20 is a flowchart depicting a process for generating security attributes to be associated with an endpoint in conjunction with the endpoint's GEOL data;

FIGS. 21A-21B is a pair of a flowcharts depicting a process for detecting movement of endpoints from one geographic location to another geographic location;

FIG. 22 is a block diagram depicting components within the network management framework for managing resources within a distributed data processing system in accordance with geographic boundaries;

FIG. 23 is a block diagram depicting a simple QSGB topology map;

FIG. 24 is a flowchart depicting a process through which geographic boundaries can be configured;

FIG. 25 is a flowchart depicting a process for configuring and using security access rights to boundary objects; and

FIGS. 26A-26B are a pair of flowcharts depicting a process for quarantining devices within secure geographic boundaries.

### DETAILED DESCRIPTION OF THE INVENTION

The present invention provides a methodology for managing a distributed data processing system. The manner in which the system management is performed is described further below in more detail after the description of the preferred embodiment of the distributed computing environment in which the present invention operates.

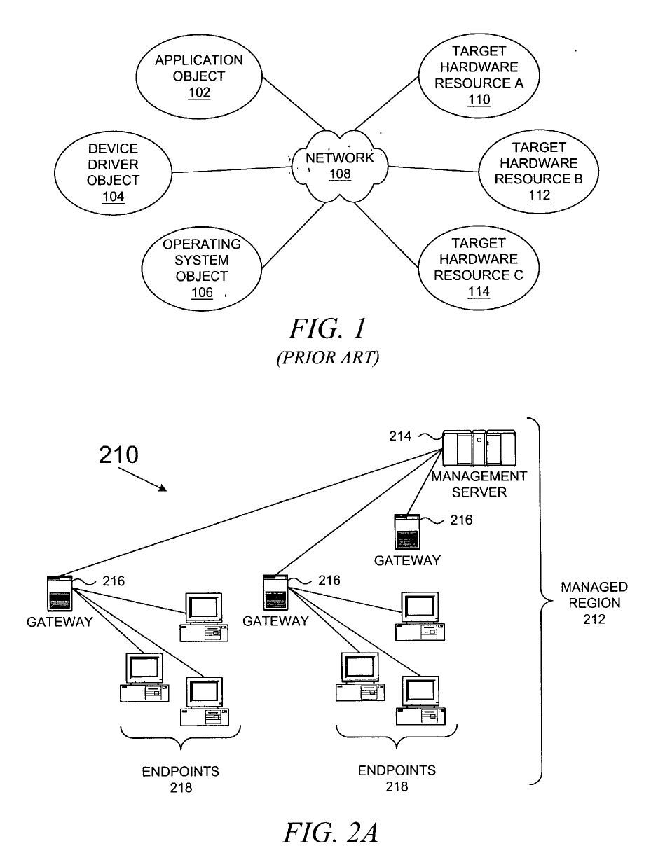

With reference now to FIG. 1, a diagram depicts a known logical configuration of software and hardware resources. In this example, the software is organized in an object-oriented system. Application object 102, device driver object 104, and operating system object 106 communicate across network 108 with other objects and with hardware resources 110-114.

In general, the objects require some type of processing, input/output, or storage capability from the hardware resources. The objects may execute on the same device to which the hardware resource is connected, or the objects may be physically dispersed throughout a distributed computing environment. The objects request access to the hardware resource in a variety of manners, e.g. operating system calls to device drivers. Hardware resources are generally available on a first-come, first-serve basis in conjunction with some type of arbitration scheme to ensure that the requests for resources are fairly handled. In some cases, priority may be given to certain requesters, but in most implementations, all requests are eventually processed.

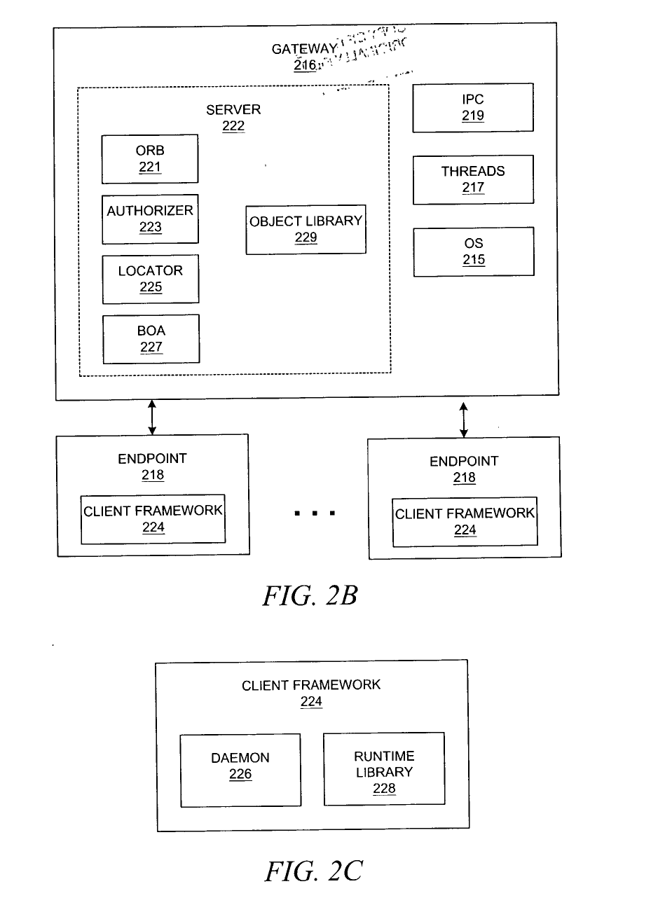

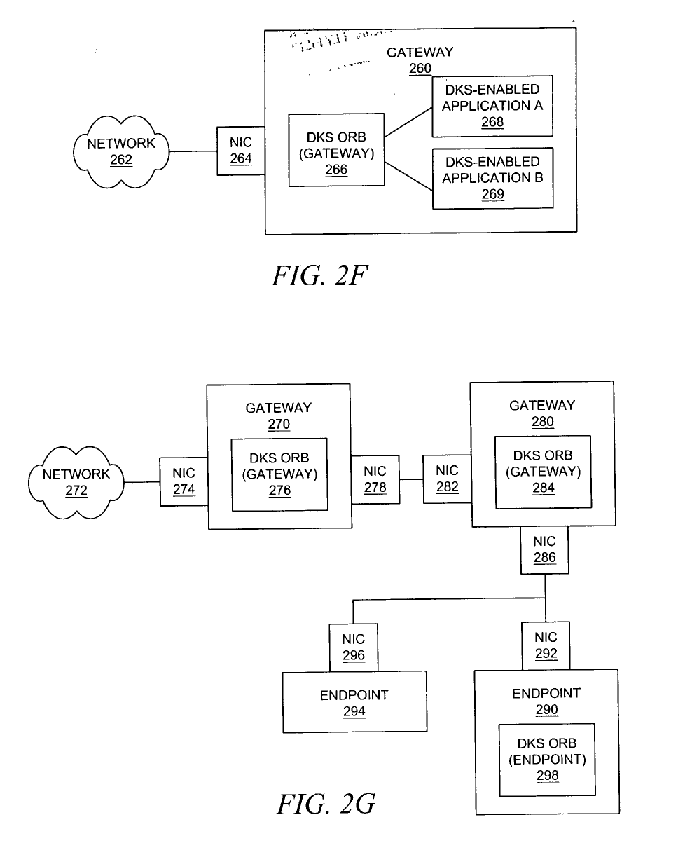

With reference now to FIG. 2A, the present invention is preferably implemented in a large distributed computer environment 210 comprising up to thousands of “nodes”. The nodes will typically be geographically dispersed and the overall environment is “managed” in a distributed manner. Preferably, the managed environment is logically broken down into a series of loosely connected managed regions (MRs) 212, each with its own management server 214 for managing local resources with the managed region. The network typically will include other servers (not shown) for carrying out other distributed network functions. These include name servers, security servers, file servers, thread servers, time servers and the like. Multiple servers 214 coordinate activities across the enterprise and permit remote management and operation. Each server 214 serves a number of gateway machines 216, each of which in turn support a plurality of endpoints/terminal nodes 218. The server 214 coordinates all activity within the managed region using a terminal node manager at server 214.

With reference now to FIG. 2B, each gateway machine 216 runs a server component 222 of a system management framework. The server component 222 is a multi-threaded runtime process that comprises several components: an object request broker (ORB) 221, an authorization service 223, object location service 225 and basic object adapter (BOA) 227. Server component 222 also includes an object library 229. Preferably, ORB 221 runs continuously, separate from the operating system, and it communicates with both server and client processes through separate stubs and skeletons via an interprocess communication (IPC) facility 219. In particular, a secure remote procedure call (RPC) is used to invoke operations on remote objects. Gateway machine 216 also includes operating system 215 and thread mechanism 217.

The system management framework, also termed distributed kernel services (DKS), includes a client component 224 supported on each of the endpoint machines 218. The client component 224 is a low cost, low maintenance application suite that is preferably “dataless” in the sense that system management data is not cached or stored there in a persistent manner. Implementation of the management framework in this “client-server” manner has significant advantages over the prior art, and it facilitates the connectivity of personal computers into the managed environment. It should be noted, however, that an endpoint may also have an ORB for remote object-oriented operations within the distributed environment, as explained in more detail further below.

Using an object-oriented approach, the system management framework facilitates execution of system management tasks required to manage the resources in the managed region. Such tasks are quite varied and include, without limitation, file and data distribution, network usage monitoring, user management, printer or other resource configuration management, and the like. In a preferred implementation, the object-oriented framework includes a Java runtime environment for well-known advantages, such as platform independence and standardized interfaces. Both gateways and endpoints operate portions of the system management tasks through cooperation between the client and server portions of the distributed kernel services.

In a large enterprise, such as the system that is illustrated in FIG. 2A, there is preferably one server per managed region with some number of gateways. For a workgroup-size installation, e.g., a local area network, a single server-class machine may be used as both a server and a gateway. References herein to a distinct server and one or more gateway(s) should thus not be taken by way of limitation as these elements may be combined into a single platform. For intermediate size installations, the managed region grows breadth-wise, with additional gateways then being used to balance the load of the endpoints.

The server is the top-level authority over all gateways and endpoints. The server maintains an endpoint list, which keeps track of every endpoint in a managed region. This list preferably contains all information necessary to uniquely identify and manage endpoints including, without limitation, such information as name, location, and machine type. The server also maintains the mapping between endpoints and gateways, and this mapping is preferably dynamic.

As noted above, there are one or more gateways per managed region. Preferably, a gateway is a fully managed node that has been configured to operate as a gateway. In certain circumstances, though, a gateway may be regarded as an endpoint. A gateway always has a network interface card (NIC), so a gateway is also always an endpoint. A gateway usually uses itself as the first seed during a discovery process. Initially, a gateway does not have any information about endpoints. As endpoints login, the gateway builds an endpoint list for its endpoints. The gateway's duties preferably include: listening for endpoint login requests, listening for endpoint update requests, and (its main task) acting as a gateway for method invocations on endpoints.

As also discussed above, the endpoint is a machine running the system management framework client component, which is referred to herein as a management agent. The management agent has two main parts as illustrated in FIG. 2C: daemon 226 and application runtime library 228. Daemon 226 is responsible for endpoint login and for spawning application endpoint executables. Once an executable is spawned, daemon 226 has no further interaction with it. Each executable is linked with application runtime library 228, which handles all further communication with the gateway.

Each endpoint is also a computing device. In one preferred embodiment of the invention, most of the endpoints are personal computers, e.g., desktop machines or laptops. In this architecture, the endpoints need not be high powered or complex machines or workstations. An endpoint computer preferably includes a Web browser such as Netscape Navigator or Microsoft Internet Explorer. An endpoint computer thus may be connected to a gateway via the Internet, an intranet, or some other computer network.

Preferably, the client-class framework running on each endpoint is a low-maintenance, low-cost framework that is ready to do management tasks but consumes few machine resources because it is normally in an idle state. Each endpoint may be “dataless” in the sense that system management data is not stored therein before or after a particular system management task is implemented or carried out.

With reference now to FIG. 2D, a diagram depicts a logical configuration of software objects residing within a hardware network similar to that shown in FIG. 2A. The endpoints in FIG. 2D are similar to the endpoints shown in FIG. 2B. Object-oriented software, similar to the collection of objects shown in FIG. 1, executes on the endpoints. Endpoints 230 and 231 support application action object 232 and application object 233, device driver objects 234-235, and operating system objects 236-237 that communicate across a network with other objects and hardware resources.

Resources can be grouped together by an enterprise into managed regions representing meaningful groups. Overlaid on these regions are domains that divide resources into groups of resources that are managed by gateways. The gateway machines provide access to the resources and also perform routine operations on the resources, such as polling. FIG. 2D shows that endpoints and objects can be grouped into managed regions that represent branch offices 238 and 239 of an enterprise, and certain resources are controlled by central office 240. Neither a branch office nor a central office is necessarily restricted to a single physical location, but each represents some of the hardware resources of the distributed application framework, such as routers, system management servers, endpoints, gateways, and critical applications, such as corporate management Web servers. Different types of gateways can allow access to different types of resources, although a single gateway can serve as a portal to resources of different types.

With reference now to FIG. 2E, a diagram depicts the logical relationships between components within a system management framework that includes two endpoints and a gateway. FIG. 2E shows more detail of the relationship between components at an endpoint. Network 250 includes gateway 251 and endpoints 252 and 253, which contain similar components, as indicated by the similar reference numerals used in the figure. An endpoint may support a set of applications 254 that use services provided by the distributed kernel services 255, which may rely upon a set of platform-specific operating system resources 256. Operating system resources may include TCP/IP-type resources, SNMP-type resources, and other types of resources. For example, a subset of TCP/IP-type resources may be a line printer (LPR) resource that allows an endpoint to receive print jobs from other endpoints. Applications 254 may also provide self-defined sets of resources that are accessible to other endpoints. Network device drivers 257 send and receive data through NIC hardware 258 to support communication at the endpoint.

With reference now to FIG. 2F, a diagram depicts the logical relationships between components within a system management framework that includes a gateway supporting two DKS-enabled applications. Gateway 260 communicates with network 262 through NIC 264. Gateway 260 contains ORB 266 that supports DKS-enabled applications 268 and 269. FIG. 2F shows that a gateway can also support applications. In other words, a gateway should not be viewed as merely being a management platform but may also execute other types of applications.

With reference now to FIG. 2G, a diagram depicts the logical relationships between components within a system management framework that includes two gateways supporting two endpoints. Gateway 270 communicates with network 272 through NIC 274. Gateway 270 contains ORB 276 that may provide a variety of services, as is explained in more detail further below. In this particular example, FIG. 2G shows that a gateway does not necessarily connect with individual endpoints.

Gateway 270 communicates through NIC 278 and network 279 with gateway 280 and its NIC 282. Gateway 280 contains ORB 284 for supporting a set of services. Gateway 280 communicates through NIC 286 and network 287 to endpoint 290 through its NIC 292 and to endpoint 294 through its NIC 296. Endpoint 290 contains ORB 298 while endpoint 294 does not contain an ORB. In this particular example, FIG. 2G also shows that an endpoint does not necessarily contain an ORB. Hence, any use of endpoint 294 as a resource is performed solely through management processes at gateway 280.

FIGS. 2F and 2G also depict the importance of gateways in determining routes/data paths within a highly distributed system for addressing resources within the system and for performing the actual routing of requests for resources. The importance of representing NICs as objects for an object-oriented routing system is described in more detail further below.

As noted previously, the present invention is directed to a methodology for managing a distributed computing environment. A resource is a portion of a computer system's physical units, a portion of a computer system's logical units, or a portion of the computer system's functionality that is identifiable or addressable in some manner to other physical or logical units within the system.

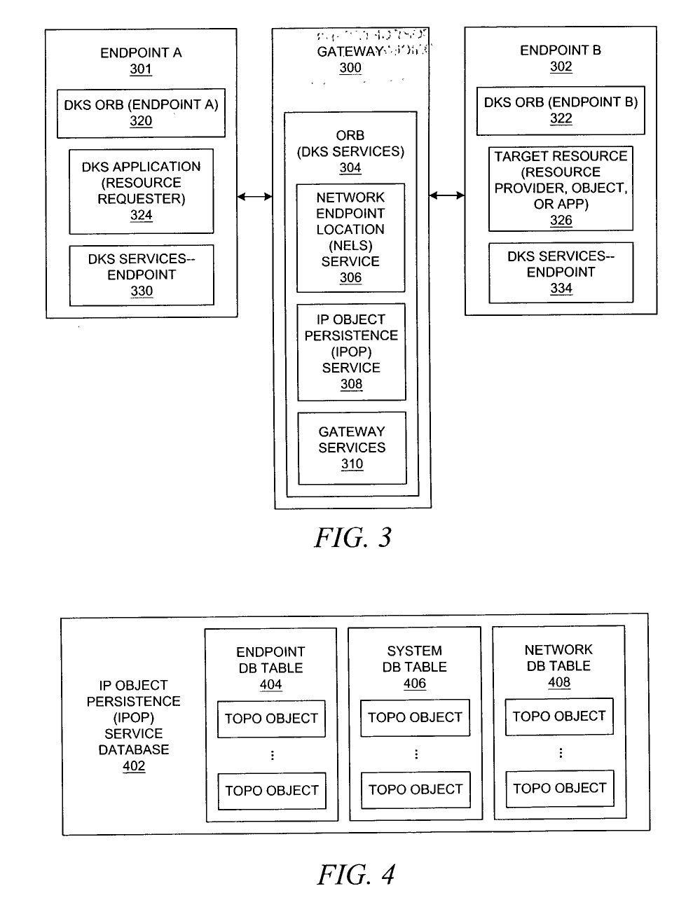

With reference now to FIG. 3, a block diagram depicts components within the system management framework within a distributed computing environment such as that shown in FIGS. 2D-2E. A network contains gateway 300 and endpoints 301 and 302. Gateway 302 runs ORB 304. In general, an ORB can support different services that are configured and run in conjunction with an ORB. In this case, distributed kernel services (DKS) include Network Endpoint Location Service (NELS) 306, IP Object Persistence (IPOP) service 308, and gateway service 310.

The gateway service processes action objects, which are explained in more detail below, and directly communicates with endpoints or agents to perform management operations. The gateway receives events from resources and passes the events to interested parties within the distributed system. The NELS works in combination with action objects and determines which gateway to use to reach a particular resource. A gateway is determined by using the discovery service of the appropriate topology driver, and the gateway location may change due to load balancing or failure of primary gateways.

Other resource level services may include an SNMP (Simple Network Management Protocol) service that provides protocol stacks, polling service, and trap receiver and filtering functions. The SNMP service can be used directly by certain components and applications when higher performance is required or the location independence provided by the gateways and action objects is not desired. A metadata service can also be provided to distribute information concerning the structure of SNMP agents.

The representation of resources within DKS allows for the dynamic management and use of those resources by applications. DKS does not impose any particular representation, but it does provide an object-oriented structure for applications to model resources. The use of object technology allows models to present a unified appearance to management applications and hide the differences among the underlying physical or logical resources. Logical and physical resources can be modeled as separate objects and related to each other using relationship attributes.

By using objects, for example, a system may implement an abstract concept of a router and then use this abstraction within a range of different router hardware. The common portions can be placed into an abstract router class while modeling the important differences in subclasses, including representing a complex system with multiple objects. With an abstracted and encapsulated function, the management applications do not have to handle many details for each managed resource. A router usually has many critical parts, including a routing subsystem, memory buffers, control components, interfaces, and multiple layers of communication protocols. Using multiple objects has the burden of creating multiple object identifiers (OIDs) because each object instance has its own OID. However, a first order object can represent the entire resource and contain references to all of the constituent parts.

Each endpoint may support an object request broker, such as ORBs 320 and 322, for assisting in remote object-oriented operations within the DKS environment. Endpoint 301 contains DKS-enabled application 324 that utilizes object-oriented resources found within the distributed computing environment. Endpoint 302 contains target resource provider object or application 326 that services the requests from DKS-enabled application 324. A set of DKS services 330 and 334 support each particular endpoint.

Applications require some type of insulation from the specifics of the operations of gateways. In the DKS environment, applications create action objects that encapsulate commands which are sent to gateways, and the applications wait for the return of the action object. Action objects contain all of the information necessary to run a command on a resource. The application does not need to know the specific protocol that is used to communicate with the resource. The application is unaware of the location of the gateway because it issues an action object into the system, and the action object itself locates and moves to the correct gateway. The location independence allows the NELS to balance the load between gateways independently of the applications and also allows the gateways to handle resources or endpoints that move or need to be serviced by another gateway.

The communication between a gateway and an action object is asynchronous, and the action objects provide error handling and recovery. If one gateway goes down or becomes overloaded, another gateway is located for executing the action object, and communication is established again with the application from the new gateway. Once the controlling gateway of the selected endpoint has been identified, the action object will transport itself there for further processing of the command or data contained in the action object. If it is within the same ORB, it is a direct transport. If it is within another ORB, then the transport can be accomplished with a “Moveto” command or as a parameter on a method call.

Queuing the action object on the gateway results in a controlled process for the sending and receiving of data from the IP devices. As a general rule, the queued action objects are executed in the order that they arrive at the gateway. The action object may create child action objects if the collection of endpoints contains more than a single ORB ID or gateway ID. The parent action object is responsible for coordinating the completion status of any of its children. The creation of child action objects is transparent to the calling application. A gateway processes incoming action objects, assigns a priority, and performs additional security challenges to prevent rogue action object attacks. The action object is delivered to the gateway that must convert the information in the action object to a form suitable for the agent. The gateway manages multiple concurrent action objects targeted at one or more agents, returning the results of the operation to the calling application as appropriate.

In the preferred embodiment, potentially leasable target resources are Internet protocol (IP) commands, e.g. pings, and Simple Network Management Protocol (SNMP) commands that can be executed against endpoints in a managed region. Referring again to FIGS. 2F and 2G, each NIC at a gateway or an endpoint may be used to address an action object. Each NIC is represented as an object within the IPOP database, which is described in more detail further below.

The Action Object IP (AOIP) Class is a subclass of the Action Object Class. An AOIP object is the primary vehicle that establishes a connection between an application and a designated IP endpoint using a gateway or stand-alone service. In addition, the Action Object SNMP (AOSnmp) Class is also a subclass of the Action Object Class. An AOSnmp object is the primary vehicle that establishes a connection between an application and a designated SNMP endpoint via a gateway or the gateway service. However, the present invention is primarily concerned with IP endpoints.

The AOIP class should include the following: a constructor to initialize itself; an interface to the NELS; a mechanism by which the action object can use the ORB to transport itself to the selected gateway; a security check verification of access rights to endpoints; a container for either data or commands to be executed at the gateway; a mechanism by which to pass commands or classes to the appropriate gateway or endpoint for completion; and public methods to facilitate the communication between objects.

The instantiation of an AOIP object creates a logical circuit between an application and the targeted gateway or endpoint. This circuit is persistent until command completion through normal operation or until an exception is thrown. When created, the AOIP object instantiates itself as an object and initializes any internal variables required. An AOIP may be capable of running a command from inception or waiting for a future command. A program that creates an AOIP object must supply the following elements: address of endpoints; function to be performed on the endpoint; and data arguments specific to the command to be run. A small part of the action object must contain the return end path for the object. This may identify how to communicate with the action object in case of a breakdown in normal network communications. An action object can contain either a class or object containing program information or data to be delivered eventually to an endpoint or a set of commands to be performed at the appropriate gateway. Action objects IP return back a result for each address endpoint targeted.

Using commands such as “Ping”, “Trace Route”, “Wake-On LAN”, and “Discovery”, the AOIP object performs the following services: facilitates the accumulation of metrics for the user connections; assists in the description of the topology of a connection; performs Wake-On LAN tasks using helper functions; and discovers active agents in the network environment.

The NELS service finds a route to communicate between the application and the appropriate endpoint. The NELS service converts input to protocol, network address, and gateway location for use by action objects. The NELS service is a thin service that supplies information discovered by the IPOP service. The primary roles of the NELS service are as follows: support the requests of applications for routes; maintain the gateway and endpoint caches that keep the route information; ensure the security of the requests; and perform the requests as efficiently as possible to enhance performance.

For example, an application requires a target endpoint (target resource) to be located. The target is ultimately known within the DKS space using traditional network values, i.e. a specific network address and a specific protocol identifier. An action object is generated on behalf of an application to resolve the network location of an endpoint. The action object asks the NELS service to resolve the network address and define the route to the endpoint in that network.

One of the following is passed to the action object to specify a destination endpoint: an EndpointAddress object; a fully decoded NetworkAddress object; or a string representing the IP address of the IP endpoint. In combination with the action objects, the NELS service determines which gateway to use to reach a particular resource. The appropriate gateway is determined using the discovery service of the appropriate topology driver and may change due to load balancing or failure of primary gateways. An “EndpointAddress” object must consist of a collection of at least one or more unique managed resource IDs. A managed resource ID decouples the protocol selection process from the application and allows the NELS service to have the flexibility to decide the best protocol to reach an endpoint. On return from the NELS service, an “AddressEndpoint” object is returned, which contains enough information to target the best place to communicate with the selected IP endpoints. It should be noted that the address may include protocol-dependent addresses as well as protocol-independent addresses, such as the virtual private network id and the IPOP Object ID. These additional addresses handle the case where duplicate addresses exist in the managed region.

When an action needs to be taken on a set of endpoints, the NELS service determines which endpoints are managed by which gateways. When the appropriate gateways are identified, a single copy of the action object is distributed to each identified gateway. The results from the endpoints are asynchronously merged back to the caller application through the appropriate gateways. Performing the actions asynchronously allows for tracking all results whether the endpoints are connected or disconnected. If the action object IP fails to execute on its target gateway, NELS is consulted to identify an alternative path for the command. If an alternate path is found, the action object IP is transported to that gateway and executed. It may be assumed that the entire set of commands within one action object IP must fail before this recovery procedure is invoked.

With reference now to FIG. 4, a block diagram shows the manner in which data is stored by the IPOP (IP Object Persistence) service. IPOP service database 402 contains endpoint database table 404, system database table 406, and network database table 408. Each table contains a set of topological objects (TopoObjects) for facilitating the leasing of resources at IP endpoints and the execution of action objects. Information within IPOP service database 402 allows applications to generate action objects for resources previously identified as IP objects through a discovery process across the distributed computing environment. FIG. 4 merely shows that the TopoObjects may be separated into a variety of categories that facilitate processing on the various objects. The separation of physical network categories facilitates the efficient querying and storage of these objects while maintaining the physical network relationships in order to produce a graphical user interface of the network topology.

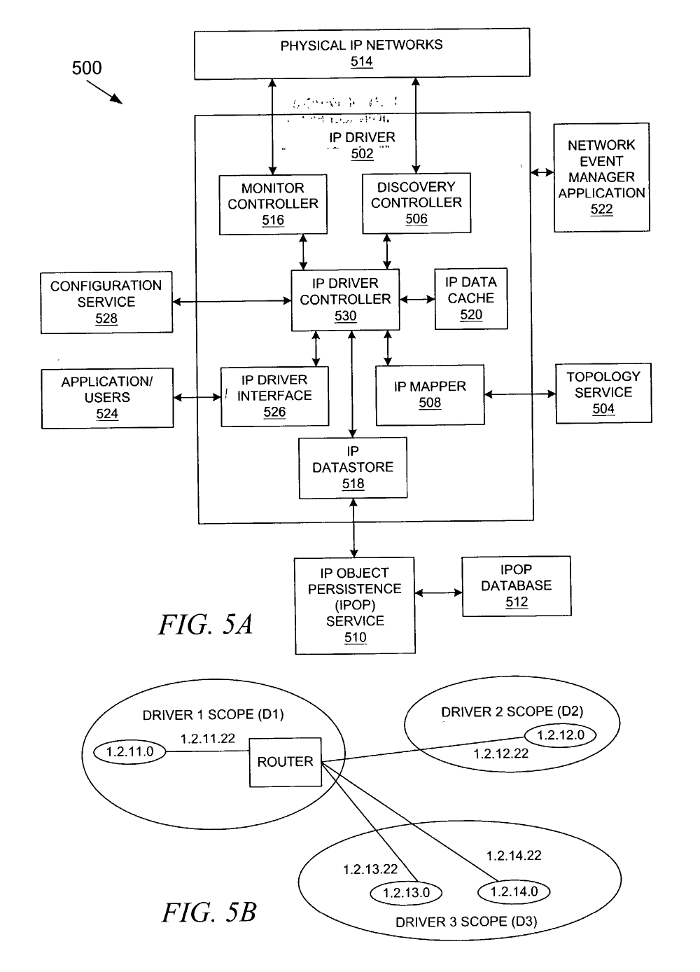

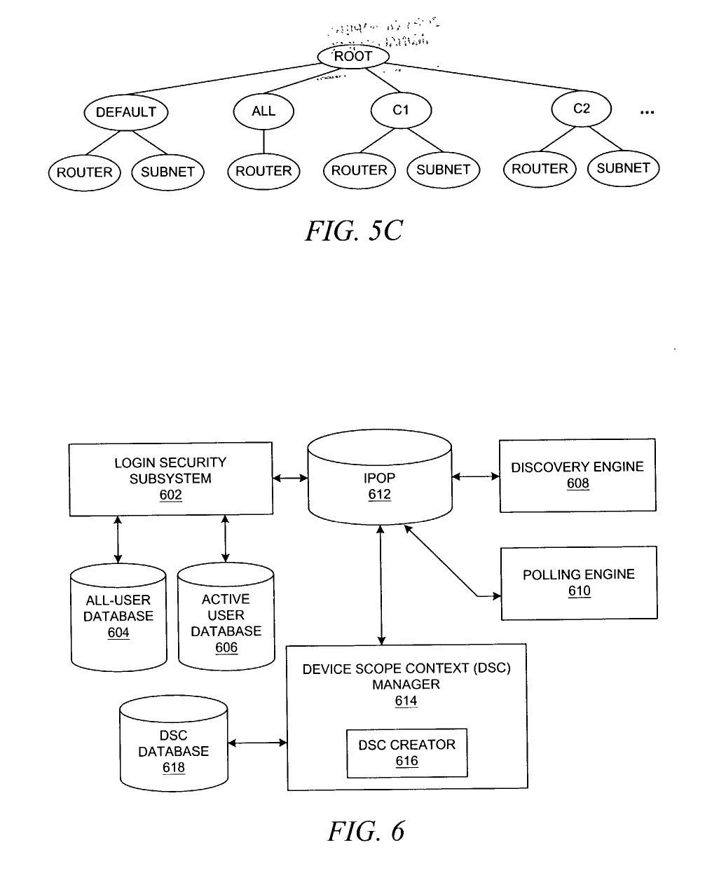

With reference now to FIG. 5A, a block diagram shows the IPOP service in more detail. In the preferred embodiment of the present invention, an IP driver subsystem is implemented as a collection of software components for discovering, i.e. detecting, IP “objects”, i.e. IP networks, IP systems, and IP endpoints by using physical network connections. This discovered physical network is used to create topology data that is then provided through other services via topology maps accessible through a graphical user interface (GUI) or for the manipulation of other applications. The IP driver system can also monitor objects for changes in IP topology and update databases with the new topology information. The IPOP service provides services for other applications to access the IP object database.

IP driver subsystem 500 contains a conglomeration of components, including one or more IP drivers 502. Every IP driver manages its own “scope”, which is described in more detail further below, and every IP driver is assigned to a topology manager within topology service 504, which can serve more than one IP driver. Topology service 504 stores topology information obtained from discovery controller 506. The information stored within the topology service may include graphs, arcs, and the relationships between nodes determined by IP mapper 508. Users can be provided with a GUI to navigate the topology, which can be stored within a database within the topology service.

IPOP service 510 provides a persistent repository 512 for discovered IP objects; persistent repository 512 contains attributes of IP objects without presentation information. Discovery controller 506 detects IP objects in Physical IP networks 514, and monitor controller 516 monitors IP objects. A persistent repository, such as IPOP database 512, is updated to contain information about the discovered and monitored IP objects. IP driver may use temporary IP data store component 518 and IP data cache component 520 as necessary for caching IP objects or storing IP objects in persistent repository 512, respectively. As discovery controller 506 and monitor controller 516 perform detection and monitoring functions, events can be written to network event manager application 522 to alert network administrators of certain occurrences within the network, such as the discovery of duplicate IP addresses or invalid network masks.

External applications/users 524 can be other users, such as network administrators at management consoles, or applications that use IP driver GUI interface 526 to configure IP driver 502, manage/unmanage IP objects, and manipulate objects in persistent repository 512. Configuration service 528 provides configuration information to IP driver 502. IP driver controller 530 serves as central control of all other IP driver components.

Although network information discovered by the IP driver subsystem can be obtained by use of a simple command line interface, most of today's software products require a GUI interface to promote ease of use. The topology service has been made available for displaying objects and relationships to users; however, this service is somewhat “generic” in that it is available for a multitude of services to utilize. Therefore, a mechanism is necessary for interpreting what the IP driver service discovers and telling topology how to display this information. This mechanism is referred to as IP mapper.

The major advantage of the IP mapper is that it allows the topology service to remain “generic”; topology remains a service for a variety of components to use rather than having to contain IP driver-specific logic. The topology service provides four types of objects to its customers: Aggregate Topology Objects, Topology Objects, Resources, and Relationships. IP mapper allows the topology service to work independently of IP driver through the following means. First of all, IP mapper creates its own resources to use, so that the topology service toes not have to provide resource types. Resources and their associated data fields are declared in an XML file. IP mapper declares four types of resources: networks, systems, routers, and endpoints. Each created resource dictates the image displayed to represent the resource as well as what data is contained by a resource. Secondly, IP mapper creates Aggregate Topology Objects to represent each network, system, or router that IP driver discovers. Relationships are then formed between the systems, networks, and routers in which they reside. Third, discovered endpoints are represented by Topology Objects, and relationships are created between the endpoints and the systems and routers they reside in. Finally, if a system or router contains endpoints that reside in separate networks, virtual resources must be created. Virtual resources reside inside a network, and appear just as a system or router would but actually link back to the original router or system so that data is not duplicated and the rules of which administrators can administrate objects managed by a particular IP driver can be enforced.

As distributed computing and the reliance on large and sophisticated networks become commonplace in business, the need to discover and monitor the devices in the network is of utmost importance. The network discovery/monitor software must be suitable for very large-scale and multi-customer environments; as such, it must be scalable, flexible, reliable and secure. The configuration and runtime manipulation of this type of network discovery/monitoring service is a complicated task.

There are two main administrative tasks to be done for a distributed network discovery and monitor system: configuration and status checking.

Configuration: the network discovery/monitor service used in a large multi-customer environment must be highly configurable. The administrator must be able to define the number of distributed monitors needed, where they are located, and specific properties that will direct the behavior of each monitor. The configurable properties can include, but are not limited to:

(1) General properties, such as IP driver ID, which is a numeric identifier to distinguish an IP driver from all the others, and number of threads, which are the number of threads available to perform network discovery and polling tasks;

(2) Scope, which is one or more subnetworks that a given IP driver is responsible for discovering and monitoring;

(3) Discovery mechanisms, which are the ways a particular IP driver can discover systems within its scope and may include, but are not limited to, ping spread discovery, route table poll, ARP table poll, unsolicited ping discovery, or any combination of the above;

(4) General node information, such as: (a) polling strategy, which is the way a given node will be monitored (if any)—pings may be used to get general up/down status and SNMP queries may be used for more extensive systems (the administrator may also wish to ignore i.e not monitor, any node that is not running an SNMP agent); and (b) delete interval, which is the time to wait before a non-responding address is deleted from the data store of network objects;

(5) DHCP node information, such as: (a) address range, which is the address ranges that an administrator knows to be assigned dynamically through the Dynamic Host Configuration Protocol (DHCP)—hosts with these addresses are often transient and may be treated differently from more permanent hosts that have static addresses, e.g., these nodes may be deleted from the network data if they do not respond within a shorter timeframe than non-DHCP nodes; and (b) delete interval, which is the time to wait before a non-responding DHCP address is deleted from the data store of network objects.

Status Checking: In the course of operation, the administrator may want to review or change the configured parameters of a distributed network monitor controller or may want to view the tasks currently scheduled or executing in the monitor. The status checking operations may include, but are not limited to:

(1) Configuration Status, which shows all of the current configuration parameters for this monitor;

(2) Thread Status, which shows the state of all of the polling threads in this monitor; and

(3) Task Status, which shows the state the discovery/monitor tasks currently scheduled or running.

Referring back to FIG. 2G, a network discovery engine is a distributed collection of IP drivers that are used to ensure that operations on IP objects by gateways 260, 270, and 280 can scale to a large installation and provide fault-tolerant operation with dynamic start/stop or reconfiguration of each IP driver. The IPOP service stores and retrieves information about discovered IP objects; to do so, the IPOP service uses a distributed database in order to efficiently service query requests by a gateway to determine routing, identity, or a variety of details about an endpoint. The IPOP service also services queries by the topology service in order to display a physical network or map them to a logical network, which is a subset of a physical network that is defined programmatically or by an administrator. IPOP fault tolerance is also achieved by distribution of IPOP data and the IPOP service among many Endpoint ORBs.

One or more IP drivers can be deployed to provide distribution of IP discovery and promote scalability of IP driver subsystem services in large networks where a single IP driver is not sufficient to discover and monitor all IP objects. Each IP driver performs discovery and monitoring on a collection of IP resources within the driver's “scope”. A driver's scope, which is explained in more detail below, is simply the set of IP subnets for which the driver is responsible for discovering and monitoring. Network administrators generally partition their networks into as many scopes as needed to provide distributed discovery and satisfactory performance.

A potential risk exists if the scope of one driver overlaps the scope of another, i.e. if two drivers attempt to discover/monitor the same device. Accurately defining unique and independent scopes may require the development of a scope configuration tool to verify the uniqueness of scope definitions. Routers also pose a potential problem in that while the networks serviced by the routers will be in different scopes, a convention needs to be established to specify to which network the router “belongs”, thereby limiting the router itself to the scope of a single driver.

Some ISPs may have to manage private networks whose addresses may not be unique across the installation, like 10.0.0.0 network. In order to manage private networks properly, first, the IP driver has to be installed inside the internal networks in order to be able to discover and manage the networks. Second, since the discovered IP addresses may not be unique across an entire installation that consists of multiple regions, multiple customers, etc., a private network ID has to be assigned to the private network addresses. In the preferred embodiment, the unique name of a subnet becomes “privateNetworkId\subnetAddress”. Those customers that do not have duplicate networks address can just ignore the private network ID; the default private network ID is 0.

If Network Address Translator (NAT) is installed to translate the internal IP addresses to Internet IP addresses, users can install the IP drivers outside of NAT and manage the IP addresses inside the NAT. In this case, an IP driver will see only the translated IP addresses and discover only the IP addresses translated. If not all IP addresses inside the NAT are translated, an IP driver will not able to discover all of them. However, if IP drivers are installed this way, users do not have to configure the private network within the IP driver's scope.

Scope configuration is important to the proper operation of the IP drivers because IP drivers assume that there are no overlaps in the drivers' scopes. Since there should be no overlaps, every IP driver has complete control over the objects within its scope. A particular IP driver does not need to know anything about the other IP drivers because there is no synchronization of information between IP drivers. The configuration service provides the means to allow the DKS components to store and retrieve configuration information for a variety of other services from anywhere in the networks. In particular, the scope configuration will be stored in the configuration services so that IP drivers and other applications can access the information.

The ranges of addresses that a driver will discover and monitor are determined by associating a subnet address with a subnet mask and associating the resulting range of addresses with a subnet priority. An IP driver is a collection of such ranges of addresses, and the subnet priority is used to help decide the system address. A system can belong to two or more subnets, such as is commonly seen with a Gateway. The system address is the address of one of the NICs that is used to make SNMP queries. A user interface can be provided, such as an administrator console, to write scope information into the configuration service. System administrators do not need to provide this information at all, however, as the IP drivers can use default values.

An IP driver gets its scope configuration information from the configuration service, which may be stored using the following format:

scopeID=driverID,anchorname,subnetAddress:subnetMask[:privateNetworkId:privateNetworkName:subnetPriority] [, subnetAddress:subnetMask:privateNetworkId:privateNetworkN ame:subnetPriority]]

Typically, one IP driver manages only one scope. Hence, the “scopeID” and “driverID” would be the same. However, the configuration can provide for more than one scope managed by the same driver. “Anchorname” is the name in the name space in which the topology service will put the IP driver's network objects.

A scope does not have to include an actual subnet configured in the network. Instead, users/administrators can group subnets into a single, logical scope by applying a bigger subnet mask to the network address. For example, if a system has subnet “147.0.0.0” with mask of “255.255.0.0” and subnet “147.1.0.0” with a subnet mask of “255.255.0.0”, the subnets can be grouped into a single scope by applying a mask of “255.254.0.0”. Assume that the following table is the scope of IP Driver 2. The scope configuration for IP Driver 2 from the configuration service would be:

2=2, ip,147.0.0.0:255.254.0.0,146.100.0.0:255.255.0.0, 69.0.0.0:255.0.0.0.

| Subnet address | Subnet mask |
|---|---|
| 147.0.0.0 | 255.255.0.0 |
| 147.1.0.0 | 255.255.0.0 |
| 146.100.0.0 | 255.255.0.0 |
| 69.0.0.0 | 255.0.0.0 |

In general, an IP system is associated with a single IP address, and the “scoping” process is a straightforward association of a driver's ID with the system's IP address.

Routers and multi-homed systems, however, complicate the discovery and monitoring process because these devices may contain interfaces that are associated with different subnets. If all subnets of routers and multi-homed systems are in the scope of the same driver, the IP driver will manage the whole system. However, if the subnets of routers and multi-homed systems are across the scopes of different drivers, a convention is needed to determine a dominant interface: the IP driver that manages the dominant interface will manage the router object so that the router is not being detected and monitored by multiple drivers; each interface is still managed by the IP driver determined by its scope; the IP address of the dominant interface will be assigned as the system address of the router or multi-homed system; and the smallest (lowest) IP address of any interface on the router will determine which driver includes the router object within its scope.

Users can customize the configuration by using the subnet priority in the scope configuration. The subnet priority will be used to determinate the dominant interface before using the lowest IP address. If the subnet priorities are the same, the lowest IP address is then used. Since the default subnet priority would be “0”, then the lowest IP address would be used by default.

With reference now to FIG. 5B, a network diagram depicts a network with a router that undergoes a scoping process. IP driver Di will include the router in its scope because the subnet associated with that router interface is lower than the other three subnet addresses. However, each driver will still manage those interfaces inside the router in its scope. Drivers D2 and D3 will monitor the devices within their respective subnets, but only driver D1 will store information about the router itself in the IPOP database and the topology service database.

If driver D1's entire subnet is removed from the router, driver D2 will become the new “owner” of the router object because the subnet address associated with driver D2 is now the lowest address on the router. Because there is no synchronization of information between the drivers, the drivers will self-correct over time as they periodically rediscover their resources. When the old driver discovers that it no longer owns the router, it deletes the router's information from the databases. When the new driver discovers the router's lowest subnet address is now within its scope, the new driver takes ownership of the router and updates the various databases with the router's information. If the new driver discovers the change before the old driver has deleted the object, then the router object may be briefly represented twice until the old owner deletes the original representation.

There are two kinds of associations between IP objects. One is “IP endpoint in IP system” and the other is “IP endpoint in IP network”. The implementation of associations relies on the fact that an IP endpoint has the object IDs (OIDs) of the IP system and the IP network in which it is located. An IP driver can partition all IP networks, IP Systems, and IP endpoints into different scopes. A network and all its IP endpoints will always be assigned in the same scope. However, a router may be assigned to an IP driver, but some of its interfaces are assigned to different IP drivers. The IP drivers that do not manage the router but manage some of its interfaces will have to create interfaces but not the router object. Since those IP drivers do not have a router object ID to assign to its managed interfaces, they will assign a unique system name instead of object ID in the IP endpoint object to provide a link to the system object in a different driver.

Because of the inter-scope association, when the IP Object Persistence Service (IPOP) is queried to find all the IP endpoints in system, it will have to search not only IP endpoints with the system ID but also IP endpoints with its system name. If a distributed IP Object Persistence Service is implemented, the service has to provide extra information for searching among its distributed instances.

An IP driver may use a security service to check access to IP objects. In order to handle large number of objects, the security service requires the users to provide a naming hierarchy as the grouping mechanism. FIG. 5C, described below, shows a security naming hierarchy of IP objects. An IP driver has to allow users to provide security down to the object level and to achieve high performance. In order to achieve this goal, the concepts of “anchor” and “unique object name” are introduced. An anchor is a name in the naming space which can be used to plug in IP networks. Users can define, under the anchor, scopes that belong to the same customer or to a region. The anchor is then used by the security service to check if a user has access to the resource under the anchor. If users want a security group defined inside a network, the unique object name is used. A unique object name is in the format of:

IP network—privateNetworkID/binaryNetworkAddress

IP system—privateNetworkID/binaryIPAddress/system

IP endpoint-privateNetworkID/binaryNetworkAddress/endpoint

For example:

A network “146.84.28.0:255.255.255.0” in privateNetworkID 12 has unique name:

12/1/0/0/1/0/0/1/0/0/1/0/1/0/1/0/0/0/0/0/1/1/1/0/0.

A system “146.84.28.22” in privateNetworkID 12 has unique name:

12/1/0/0/1/0/0/1/0/0/1/0/1/0/1/0/0/0/0/0/1/1/1/0/0/0/0/0/1/0/1/1/0/system.

An endpoint “146.84.28.22” in privateNetworkId 12 has unique name:

12/1/0/0/1/0/0/1/0/0/1/0/1/0/1/0/0/0/0/0/1/1/1/0/0/0/0/0/1/0/1/1/0/endpoint.

By using an IP-address, binary-tree, naming space, one can group all the IP addresses under a subnet in the same naming space that need to be checked by the security service.

For example, one can set up all IP addresses under subnet “146.84.0.0:255.255.0.0” under the naming space 12/1/0/0/1/0/0/1/0/0/1/0/1/0/1/0/0 and set the access rights based on this node name.

With reference now to FIG. 5C, the IP Object Security Hierarchy is depicted. Under the root, there are two fixed security groups. One is “default” and the other is “all”. The name of “default” can be configured by within the configuration service. Users are allowed to configure which subnets are under which customer by using the configuration service.

Under the first level security group, there are router groups and subnet groups. Those systems that have only one interface will be placed under the subnets group. Those systems that have more than one interface will be placed under the router group; a multi-home system will be placed under the router group.

Every IP object has a “securityGroup” field to store which security group it is in. The following describes how security groups are assigned.

When a subnet is created and it is not configured for any customers, its securityGroup is “/default/subnet/subnetAddress”. When a subnet is created and it is configured in the “customer1” domain, its “securityGroup” value is “/customer1/subnet/subnetAddress”.

When an IP endpoint is created and it is not configured for any customers, its “securityGroup” value is “/default/subnet/subnetAddress”. The subnet address is the address of the subnet in which the IP endpoint is located. When an IP endpoint is created and it is configured in the “customer1” domain, its “securityGroup” value is “/customer1/subnet/subnetAddress”. The subnet address is the address of the subnet in which the IP endpoint is located.

When a single interface IP system is created, it has the same “securityGroup” value that its interface has. When a router or multi-home system is created, the “securityGroup” value depends on whether all of the interfaces in the router or multi-home system are in the same customer group or not. If all of the interfaces of the router or multi-home system are in the same customer group, e.g., “customer1”, its “securityGroup” value is “/customer1/router”. If the interfaces of the router or multi-home system are in more than one domain, its “securityGroup” value is “/all/router”.

These are the default security groups created by an IP driver. After the security group is created for an object, IP driver will not change the security group unless a customer wants to change it.

The IP Monitor Controller, shown in FIG. 5A, is responsible for monitoring the changes of IP topology and objects; as such, it is a type of polling engine, which is discussed in more detail further below. An IP driver stores the last polling times of an IP system in memory but not in the IPOP database. The last polling time is used to calculate when the next polling time will be. Since the last polling times are not stored in the IPOP database, when an IP Driver initializes, it has no knowledge about when the last polling times occurred. If polling is configured to occur at a specific time, an IP driver will do polling at the next specific polling time; otherwise, an IP driver will spread out the polling in the polling interval.

The IP Monitor Controller uses SNMP polls to determine if there have been any configuration changes in an IP system. It also looks for any IP endpoints added to or deleted from an IP system. The IP Monitor Controller also monitors the statuses of IP endpoints in an IP system. In order to reduce network traffic, an IP driver will use SNMP to get the status of all IP endpoints in an IP system in one query unless an SNMP agent is not running on the IP system. Otherwise, an IP driver will use “Ping” instead of SNMP. An IP driver will use “Ping” to get the status of an IP endpoint if it is the only IP endpoint in the system since the response from “Ping” is quicker than SNMP.

The DKS network management framework flexibly manages multiple customers within a highly distributed system. The network management framework allows for a variety of dynamic reconfigurations of logical networks for multiple customers. The configuration is performed in a distributed manner that allows both a multi-customer service provider and its customers to have some control over the configuration and operation of the network management framework.

The distributed nature of this system allows the network to be partitioned into manageable scopes, so that any one IP driver in the system is not overloaded. The data is cached only to configured memory limits and the bulk of the data is stored and fetched from persistent storage. These factors enable a distributed monitoring system to handle very large networks (on the order of millions of devices). As a comparison, IBM's NetView product is limited to approximately 20,000 devices. In the system described, configuration data is stored in a central location with a small amount of overriding system-specific residing locally, allowing for easy administration of many independently functioning monitors.

The distributed nature of this system allows malfunctions to be limited to a fraction of the total monitored network. Failover capability in the encompassing system assure quick restart of a failed network monitor, even if it means moving the functionality to a different machine.

Configuration parameters allow each IP driver in the monitoring system to have different behavior, suited to the particular machine it runs on and the network it is operating on. A variety of discovery mechanisms can be enabled or disabled to extract the proper amount of network data. Implementation in a platform-neutral language such as Java makes it possible to run IP drivers on numerous hardware and operating systems.

Access control applied at the object level (DKS framework, IP driver instance, network, machine, interface endpoint) guarantees that no one can access that data other than the user it is intended for. This is especially important in a multi-customer environment.

With reference now to FIG. 6, a block diagram shows a set of components that may be used to implement scope-based security access in the present invention. Login security subsystem 602 provides a typical authentication service, which may be used to verify the identity of users during a login process. All-user database 604 provides information about all users in the DKS system, and active user database 606 contains information about users that are currently logged into the DKS system.

Discovery engine 608, similar to discovery controller 506 in FIG. 5, detects IP objects within an IP network. Polling engine, similar to monitor controller 516 in FIG. 5, monitors IP objects. A persistent repository, such as IPOP database 612, is updated to contain information about the discovered and monitored IP objects. IPOP also obtains the list of all users from the security subsystem which queries its all-users database 604 when initially creating a DSC (Device Scope Context) object. During subsequent operations to map the location of a user to an ORB, the DSC manager will query the active user database 606.

The DSC manager queries IPOP for all endpoint data during the initial creation of DSCs and any additional information needed, such as decoding an ORB address to an endpoint in IPOP and back to a DSC using the IPOPOid, the ID of a network object as opposed to an address.

An administrator can fill out the security information with respect to access user or endpoint access and designate which users and endpoints will have a DSC. If not configured by the administrator, a default DSC will be used. While not all endpoints will have an associated DSC, IPOP endpoint data 612, login security subsystem 602, and security information 604 are needed in order to create the initial DSCs.

The DSC manager, acting as a DSC data consumer, explained in more detail further below, then listens on this data waiting for new endpoints or users or changes to existing ones. DSC configuration changes are advertised by a responsible network management application, such as a configuration service. Some configuration changes will trigger the creation of more DSCs, while others will cause DSC data in the DSC database to be merely updated.

All DSCs are stored in DSC database 618 by DSC creator 616, which also fetches DSCs upon configuration changes in order to determine whether or not a DSC already exists. The DSC manager primarily fetches DSCs from DSC database 618, but also adds runtime information, such as ORB ID.

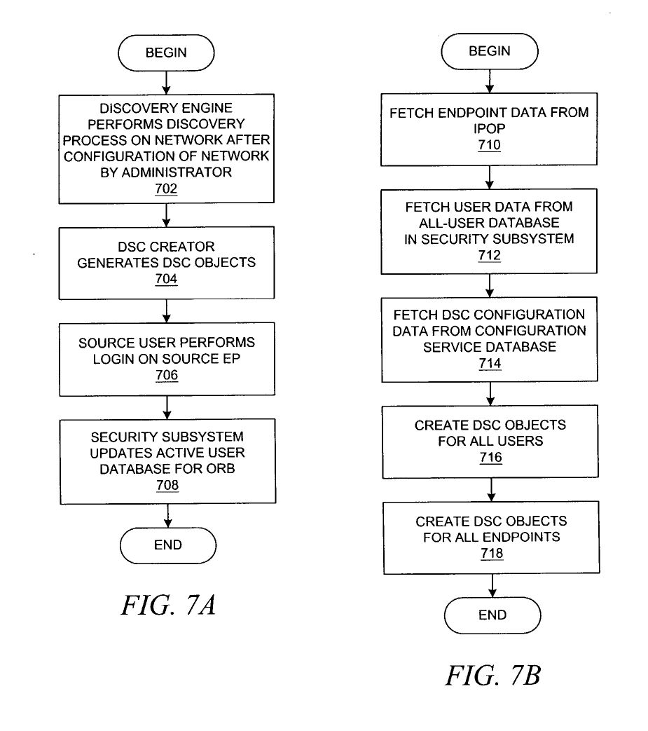

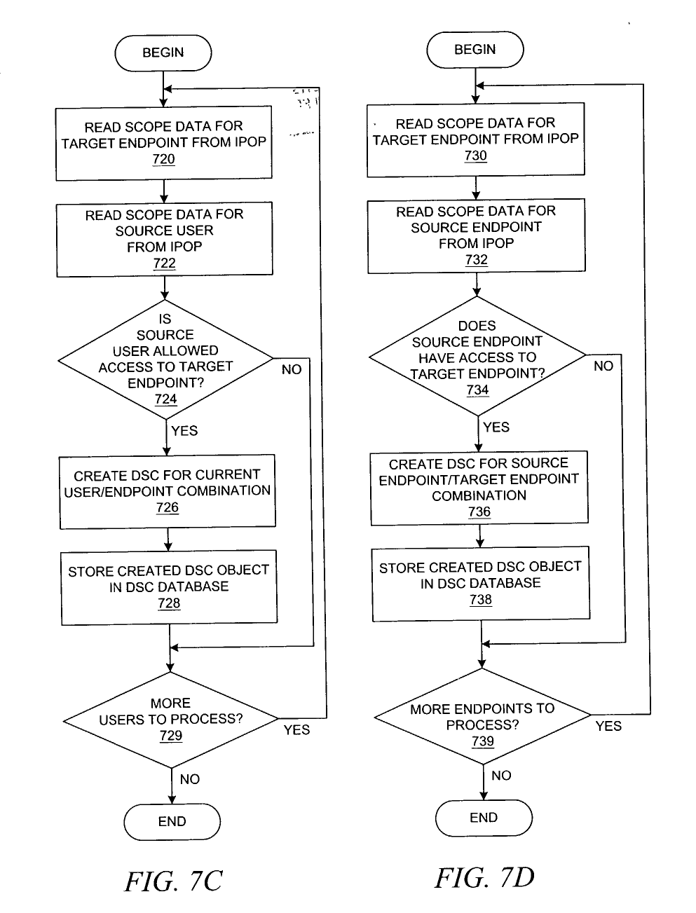

With reference now to FIG. 7A, a flowchart depicts a portion of an initialization process in which a network management system prepares a security subsystem for user access to network-related objects. The process begins with the assumption that a network administrator has already performed configuration processes on the network such that configuration information is properly stored where necessary. The discovery engine performs a discovery process to identify IP objects and stores these in the IPOP persistence storage (step 702).

The DSC creator in the DSC manager generates “initial” DSC objects and stores these within the DSC database (step 704).

A source user then performs a login on a source endpoint (step 706). An application may use a resource, termed a target resource, located somewhere within the distributed system, as described above. Hence, the endpoint on which the target resource is located is termed the “target endpoint”. The endpoint on which the application is executing is termed the “source endpoint” to distinguish it from the “target endpoint”, and the user of the application is termed the “source user”.

As part of the login process, the security subsystem updates the active user database for the ORB on which the application is executing (step 708). The initialization process is then complete.

With reference now to FIG. 7B, a flowchart depicts further detail of the initialization process in which the DSC objects are initially created and stored. FIG. 7B provides more detail for step 704 shown in FIG. 7A.

The process shown in FIG. 7B provides an outline for the manner in which the DSC manager sets up associations between users and endpoints and between endpoints and endpoints. These associations are stored as special objects termed “DSC objects”. A DSC object is created for all possible combinations of users and endpoints and for all possible combinations of endpoints and endpoints. From one perspective, each DSC object provides guidance on a one-to-one authorization mapping between two points in which a first point (source point) can be a user or an endpoint and a second point (target point) is an endpoint.

FIG. 7B depicts the manner in which the DSC manager initially creates and stores the DSC objects for subsequent use. At some later point in time, a user associated with an application executing on a source endpoint may request some type of network management action at a target endpoint, or a network management application may automatically perform an action at a target endpoint on behalf of a user that has logged into a source endpoint. Prior to completing the necessary network management task, the system must check whether the source user has the proper authorization to perform the task at the target endpoint.

Not all network monitoring and management tasks require that a user initiate the task. Some network management applications will perform tasks automatically without a user being logged onto the system and using the network management application. At some point in time, an application executing on a source endpoint may automatically attempt to perform an action at a target endpoint. Prior to completing the necessary network management task, the system must check whether the source endpoint has the proper authorization to perform the task at the target endpoint in a manner similar to the case of the source user performing an action at a target endpoint.

When the system needs to perform an authorization process, the previously created and stored DSC objects can be used to assist in the authorization process. By storing the DSC objects within a distributed database, a portion of the authorization process has already been completed. Hence, the design of the system has required a tradeoff between time and effort invested during certain system configuration processes and time and effort invested during certain runtime processes. A configuration process may require more time to complete while the DSC objects are created, but runtime authorization processes become much more efficient.

The DSC objects are created and stored within a distributed database during certain configuration processes throughout the system. A new system usually undergoes a significant installation and configuration process. However, during the life of the system, endpoints may be added or deleted, and each addition or deletion generally requires some type of configuration process. Hence, the DSC objects can be created or deleted as needed on an ongoing basis.

The network management framework also provides an additional advantage by storing the DSC objects within a highly distributed database. Because the present invention provides a network management system for an application framework over a highly distributed data processing system, the system avoids centralized bottlenecks that could occur if the authorization processes had to rely upon a centralized security database or application. The first DSC fetch requires relatively more time than might be required with a centralized subsystem. However, once fetched, a DSC is cached until listeners on the configuration data signal that a change has occurred, at which point the DSC cache must be flushed.

The process in FIG. 7B begins with the DSC manager fetching endpoint data from the IPOP database (step 710). The IPOP database was already populated with IP objects during the discovery process, as mentioned in step 702 of FIG. 7A. The DSC manager fetches user data from the all-user database in the security subsystem (step 712). Configuration data is also fetched from the configuration service database or databases (step 714), such as ORB IDs that are subsequently used to fetch the ORB address. A network administration application will also use the configuration service to store information defined by the administrator. The DSC manager then creates DSC objects for each user/endpoint combination (step 716) and for each endpoint/endpoint combination (step 718), and the DSC object creation process is then complete.

With reference now to FIG. 7C, a flowchart depicts further detail of the initial DSC object creation process in which DSC objects are created and stored for an endpoint/user combination. FIG. 7C provides more detail for step 716 in FIG. 7B. The process shown in FIG. 7C is a loop through all users that can be identified within the all-user database. In other words, a set of user accounts or identities have already been created and stored over time. However, all users that have been authorized to use the system do not have the same authorized privileges. The process shown in FIG. 7C is one of the first steps towards storing information that will allow the system to differentiate between users so that it can adaptively monitor the system based partially on the identity of the user for which the system is performing a monitoring task.

The process in FIG. 7C begins by reading scope data for a target endpoint from the IPOP database (step 720). The DSC creator within the DSC manager then reads scope data for a source user from the IPOP database (step 722). A determination is then made as to whether or not the source user is allowed to access the target endpoint (step 724). This determination can be made in the following manner. After the initial DSC is obtained, the source user information is used to make an authorization call to the security subsystem as to whether or not the source user has access to the security group defined in the DSC. It may be assumed that the security system can perform this function efficiently, although the present invention does not depend on auto-generation of security names or security trees. The present invention should not be understood as depending upon any particular implementation of security authorization.

If not, then the process branches to check whether another user identity should be processed. If the source user is allowed to access the target endpoint, then a DSC object is created for the current source user and current target endpoint that are being processed (step 726). The DSC object is then stored within the DSC database (step 728), and a check is made as to whether or not another source user identity requires processing (step 729). If so, then the process loops back to get and process another user, otherwise the process is complete.

With reference now to FIG. 7D, a flowchart depicts further detail of the initial DSC object creation process in which DSC objects are created and stored for an endpoint/endpoint combination. FIG. 7D provides more detail for step 718 in FIG. 7B. The process shown in FIG. 7D is a loop through all endpoints that can be identified within the IPOP database; the IPOP database was already populated with IP objects during the discovery process, as mentioned in step 702 of FIG. 7A. During runtime operations, an application executing on a source endpoint may attempt to perform an action at a target endpoint. However, not all endpoints within the system have access to requesting actions at all other endpoints within the system. The network management system needs to attempt to determine whether or not a source endpoint is authorized to request an action from a target endpoint. The process shown in FIG. 7D is one of the first steps towards storing information that will allow the system to differentiate between endpoints so that it can monitor the system based partially on the identity of the source endpoint for which the system is performing a monitoring task.

The process in FIG. 7D begins by reading scope data for a target endpoint from the IPOP database (step 730). The DSC creator within the DSC manager then reads scope data for a source endpoint from the IPOP database (step 732). A determination is then made as to whether or not the source endpoint is allowed to access the target endpoint (step 734) based on the scope defined in the DSC. For example, a simple scope of X.Y.Z.* will allow an address of X.Y.Z.Q access. If not, then the process branches to check whether another source endpoint should be processed. If the source endpoint is allowed to access the target endpoint, then a DSC object is created for the source endpoint and target endpoint that are currently being processed (step 736). The DSC object is then stored within the DSC database (step 738), and a check is made as to whether or not another source endpoint requires processing (step 739). If so, then the process loops back to get and process another endpoint, otherwise the process is complete.

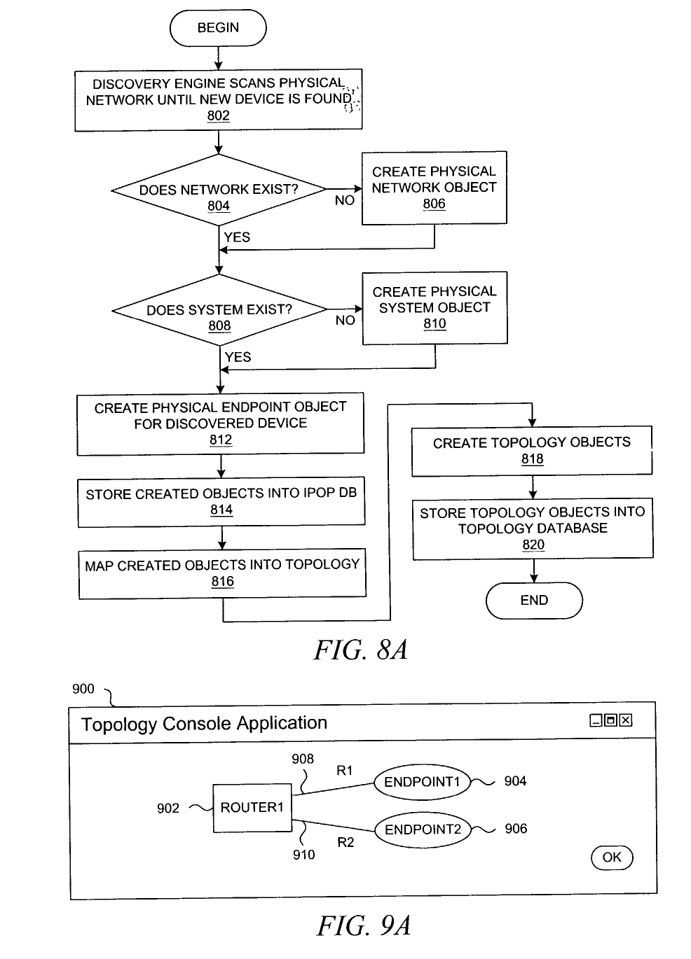

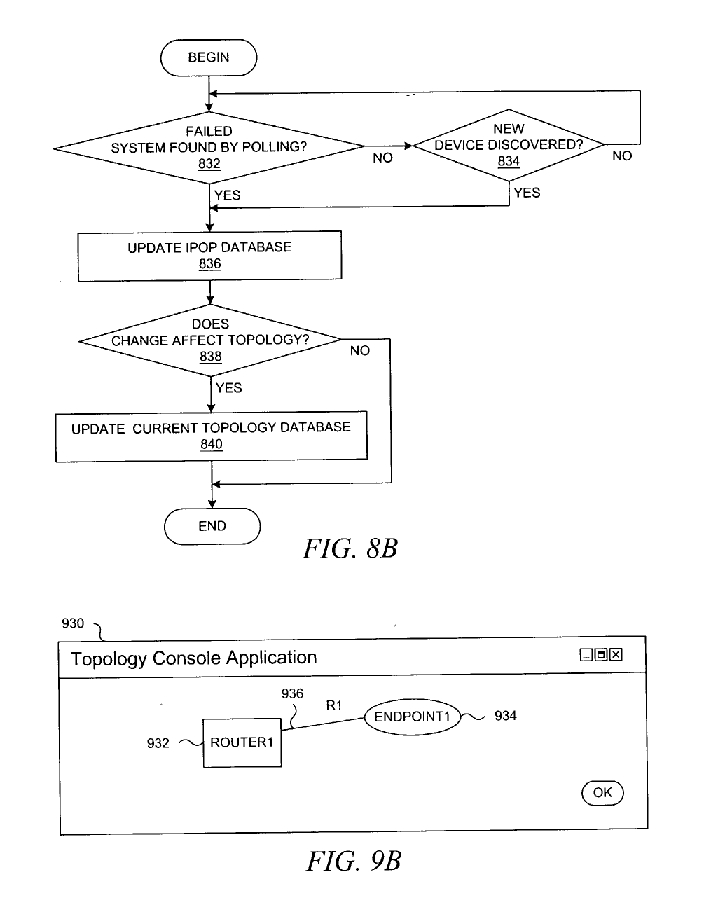

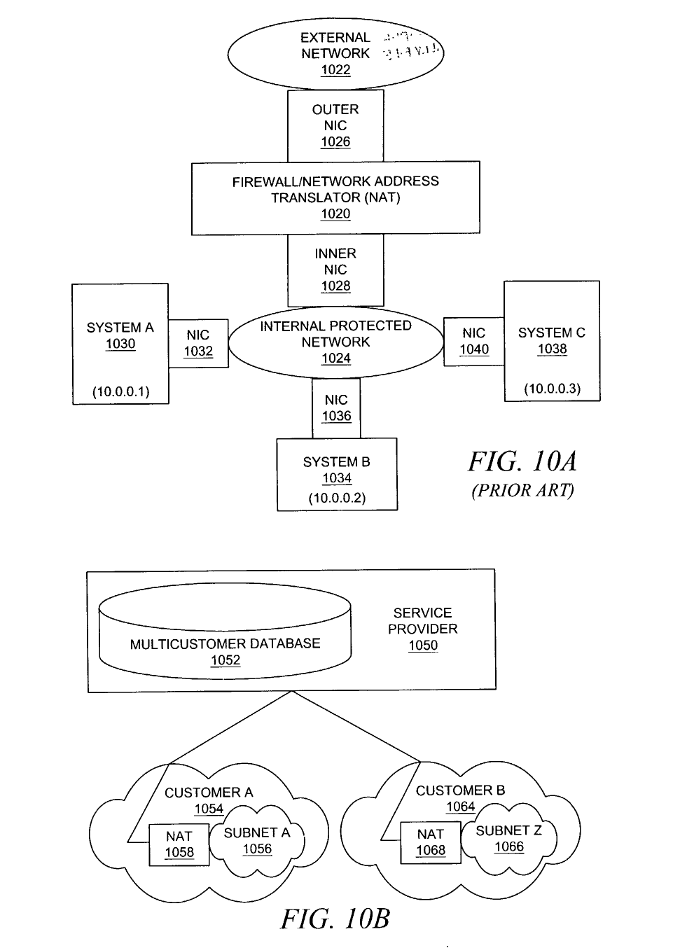

The components and subsystems described above with respect to FIGS. 6-7D are used to restrict administrative user access to various operations and functionality within the network management framework. The following description of FIGS. 8A-14B describe particular operations and functionality that may be available to administrative users within the network management framework. In particular, FIGS. 8A-14B show various ways in which scopes and anchors are used to perform certain tasks within a single network management framework that is being used to manage a multi-customer environment. More specifically, FIGS. 8A-9B depict a manner in which an administrative user may view the topology of a set of network-related objects that are being managed by the network management framework, whereas FIGS 10A-14B depict a process for configuring information within the network management framework so that it may manage the networks of multiple customers.

As described above, an IP driver subsystem is implemented as a collection of software components for discovering, i.e. detecting, network “objects”, such as IP networks, IP systems, and IP endpoints by using physical network connections. The collected data is then provided through other services via topology maps accessible through a GUI or for the manipulation of other applications. The IP driver system can also monitor objects for changes in IP topology and update databases with the new topology information. The IPOP service provides services for other applications to access the IP object database.

Referring again to FIG. 5A, IP driver subsystem 500 contains a conglomeration of components, including one or more IP drivers 502. Every IP driver manages its own “scope”, and every IP driver is assigned to a topology manager within topology service 504, which stores topology information obtained from discovery controller 506. The information stored within the topology service may include graphs, arcs, and the relationships between nodes determined by IP mapper 508. Users can be provided with a GUI to navigate the topology, which can be stored within a database within the topology service.

The topology service provides a framework for DKS-enabled applications to manage topology data. In a manner similar to the IPOP service, the topology service is actually a cluster of topology servers distributed throughout the network. All of the functions of the topology service are replicated in each topology server. Therefore, a client can attach to any server instance and perform the same tasks and access the same objects. Each topology-related database is accessible from more than one topology server, which enables the topology service to recover from a server crash and provide a way to balance the load on the service.

Topology clients create an instance of a TopoClientService class. As part of creating the TopoClientService instance, the class connects to one of the topology servers. The topology server assumes the burden of consolidating all of the topology information distributed over the different topology servers into a single combined view. The topology service tracks changes in the objects of interest for each client and notifies a client if any of the objects change.

The topology service may have a server-cluster design for maximizing availability. As long as there is at least one instance of the topology server running, then clients have access to topology objects and services. The topology service design allows for servers to occasionally fail. Each server is aware of the state of all the other server instances. If one instance fails, the other servers know immediately and automatically begin to rebuild state information that was lost by the failed server. A client's TopoClientService instance also knows of the failure of the server to which it is connected and re-connects to a different server. The objects residing at a failed topology server are migrated to the other topology servers when the drivers owning those objects have re-located.

The topology service is scalable, which is important so that the service may be the central place for all network topology objects for all of the different DKS-related applications in order to provide efficient service for millions of objects. As the number of clients, drivers, and objects increase, an administrator can create more instances of topology servers, thereby balancing the workload. Using the server cluster approach, any growth in the number of clients, drivers, and objects is accommodated by simply adding more servers. The existing servers detect the additional instances and begin to move clients and drivers over to the new instances. The automated load-balancing is achieved because the clients and objects are not dependent on any one server instance.

In order to provide a service for an entire enterprise, all of the enterprise's objects generally do not reside in the same database. There may be many reasons that make it undesirable to require that all topology objects be stored in the same database instance. For example, a database simply may not be reachable across an international boundary, or the volume of information going into the database may exceed a single database's capacity. Therefore, the topology objects may span databases, and there may be relationships between objects in different databases. However, it may be assumed that all topology objects in a domain reside in the same database. For example, all IP objects for a single enterprise do not necessarily reside in the same database as the enterprise's IP space may be split into many domains, e.g., a southwest IP domain and a northeast IP domain, but each domain may reside in different databases and still have relations between their objects. Hence, it is possible to have two objects related to each other even though they are in different databases. Since the name of the domain is part of the id of the object, each object can be uniquely identified within the entire topology service.

When an application is installed and configured to use the DKS services, the application provides some information to the topology service about the different types of TopoObjects it will be creating. This class information closely resembles the network entities that a driver will be managing. For example, an IP application works with Network, System, and Endpoint resource types, as described previously with respect to FIG. 4. Giving TopoObjects a resource type enables client applications to identify, group, and query the databases based on domain-specific types. Each resource type may have many different types of relations that the driver may create, and the most common type may be the containment relation, which shows the containment hierarchy of a domain. Each relation type has a corresponding ViewData object, which provides information that an administrative console needs to create a view of the TopoObjects. For example, the ViewData object may contain members like BackgroundColor and LayoutType that are used to construct a graphical display of the object. Relations can be created between any two TopoObjects. The TopoObjects can be owned by the same driver, different drivers in the domain, or even drivers in different domains.

With reference now to FIG. 8A, a flowchart depicts a process for creating topology data. The process begins when one or more discovery engines scan physical networks until a new device is found (step 802). A determination is made as to whether or not a network object exists for the network in which the endpoint has been found (step 804). If not, then a network object is created (step 806), otherwise the process continues.

In either case, a determination is then made as to whether or not a system object exists for the system in which the endpoint has been found (step 808). If not, then a system object is created (step 810), otherwise the process continues. In either case, an endpoint object is then created for the discovered device (step 812), and all of the created objects are then stored within the IPOP database (step 814). The created objects are then mapped into the current topology (step 816), and the topology service creates topology objects (step 818) and stores them within the topology database (step 820). The process of discovering a physical network or device and storing appropriate information is then complete.

With reference now to FIG. 8B, a flowchart depicts a process for listening for physical network changes that affect topology objects. The process begins with a determination of whether or not one or more polling engines has found a system or device that has failed (step 832). If not, then a determination is made as to whether or not a new device has been discovered (step 834). If not, then the process loops back to continue monitoring the networks.

If either a new device is discovered or a device has failed, then the appropriate changes are made to the objects representing the physical devices that have been affected by updating the IPOP database (step 836). For example, if a new device is found, then appropriate steps are made to create the necessary objects in a manner similar to steps 804-820 in FIG. 8A. A determination is then made as to whether or not the detected change affects the topology (step 838), and if not, then the process is complete. If the topology has been affected, then the topology database is updated as necessary (step 840), and the process of listening for network changes and reflecting those changes within the topology is complete.

With reference now to FIG. 9A, a figure depicts a graphical user interface window that may be used by a network or system administrator to view the topology of a network that is being monitored. Window 900 depicts a simple network showing router device 902, endpoint 904, and endpoint 906. In addition, line 908 shows a relation between endpoint 904 and router 902, and line 910 shows a relation between endpoint 906 and router 902. Each of the icons 902-906 represents a TopoObject that is maintained by the topology service.

With reference now to FIG. 9B, a figure depicts a graphical user interface window that shows the topology of a network that has changed. Window 930 in FIG. 9B shows the same network as depicted within window 900 of FIG. 9A except that an endpoint has failed and has been deleted from the current topology. Window 930 depicts a simple network showing router device 932, endpoint 934, and line 936 for the relation between endpoint 934 and router 932.

As noted previously, FIGS. 8A-9B depict one administrative operation that may be performed in conjunction with the present invention, whereas FIGS. 10A-14B depict another administrative operation; these examples are included herein to provide a context in which the network management framework uses IP drivers, scopes, anchors, and other framework components in order to provide a robust network management framework for supporting the management of the networks of multiple customers in an integrated manner.

One particular problem that a robust network management framework for a service provider must confront is the fact that many customers of a service provider may have software-based and/or hardware-based network address translators, or NATs. Each network address within a given domain serviced by a NAT can be assumed to be unique. However, across multiple NATs, each network address within the entire set of network addresses cannot be assumed to be unique. In fact, the potential for duplicate addresses over such a large, highly distributed network is quite high. Even if the service provider is managing only one customer within a particular network management environment, the same problem might also exist because a single customer may operate multiple NATs for multiple networks. This type of problem is illustrated in more detail in FIGS. 10A-10B.

With reference now to FIG. 10A, a block diagram depicts a known configuration of software and/or hardware network components linking multiple networks. A computer-type device is functioning as firewall/NAT 1020, which is usually some combination of software and hardware, to monitor data traffic from external network 1022 to internal protected network 1024. Firewall 1020 reads data received by network interface card (NIC) 1026 and determines whether the data should be allowed to proceed onto the internal network. If so, then firewall 1020 relays the data through NIC 1028. The firewall can perform similar processes for outbound data to prevent certain types of data traffic from being transmitted, such as HTTP (Hypertext Transport Protocol) Requests to certain domains.

More importantly for this context, the firewall can prevent certain types of network traffic from reaching devices that reside on the internal protected network. For example, the firewall can examine the frame types or other information of the received data packets to stop certain types of information that has been previously determined to be harmful, such as virus probes, broadcast data, pings, etc. As an additional example, entities that are outside of the internal network and lack the proper authorization may attempt to discover, through various methods, the topology of the internal network and the types of resources that are available on the internal network in order to plan electronic attacks on the network. Firewalls can prevent these types of discovery practices.

While firewalls may prevent certain entities from obtaining information from the protected internal network, firewalls may also present a barrier to the operation of legitimate, useful processes. For example, in order to ensure a predetermined level of service, benevolent processes may need to operate on both the external network and the protected internal network; a customer system is more efficiently managed if the management software can dynamically detect and dynamically configure hardware resources as they are installed, rebooted, etc. Various types of discovery processes, status polling, status gathering, etc., may be used to get information about the customer's large, dynamic, distributed processing system. This information is then used to ensure that quality-of-service guarantees to the customer are being fulfilled. However, firewalls might block these system processes, especially discovery processes.

Firewall/NAT 1020 also performs network address translation between addresses on external network 1022 and addresses on internal network 1024. In the example, system 1030 connects to internal network 1024 via NIC 1032; system 1034 connects to internal network 1024 via NIC 1036; and system 1038 connects to internal network 1024 via NIC 1040. Each NIC has its own MAC (Media Access Control layer) address, which is a guaranteed unique hardware address in the NIC that is used to address data packets to and from the system that is using a given NIC. Network Address Translator (NAT) 1020 presents all of the systems on internal network 1024 to external network 1022 with a single, public, IP address. However, systems 1030, 1034, and 1038 have addresses which are unique within internal network 1024. NAT 1020 retrieves the addresses within the data packets flowing between the internal network and the external network, translates the addresses between the two domains, stores the addresses back into the data packets, and forwards the data packets.

The internal network supports a private address space with globally non-unique address, whereas the external network represents a public address space of globally unique addresses. A NAT device is used to manage the connectivity of the private network with the outside world; the NAT device bridges the internal network and the external network and converts addresses between the two address spaces. Within a private network behind a NAT, an enterprise may have its own private address space without concern for integrating the private address space with the global Internet, particularly with the predominant IPv4 address space that is currently in use.

NATs are helpful for certain enterprises that do not require full connectivity for all of its devices. However, NATs present barriers for certain functionality. A NAT must have high performance in order to perform address translation on all data packets that are sent and received by a private network. In addition, a network management framework for a highly distributed system may be forced to coordinate its actions across multiple NAT devices within a single customer or across multiple customers. For example, systems 1030, 1034, and 1038 have addresses which are unique within internal network 1024. However, another internal network within the same enterprise may duplicate the addresses that are used within internal network 1024.

When contending with multiple NATS, the network management framework cannot assume uniqueness among private network addresses. In some prior art systems, it would have been straightforward to use the private network address of a device as a unique key within the network management applications because the private network address has a unique association with a networked device. In a highly distributed system, the network management framework needs to store many data items in an efficient manner yet cannot rely upon a scheme that uses the private network addresses as unique keys for managing those data items.

Future IT solutions may not need to confront the same problems because the Internet is moving towards using a new standard IP protocol known as IP Version 6 (IPv6) that will have a much larger address space. However, a current network management solution must confront legacy issues of maintaining currently installed hardware.

Prior art solutions have generally included dedicated boxes or devices that perform address translation. These solutions tend to be specific modifications to an operating system or kernel, which reduces the benefit of having standardized implementations of software platforms. In other words, some applications may not be compatible with the solution. In addition, such solutions may require installing a dedicated device for each system, which is prohibitive.

With reference now to FIG. 10B, a block diagram depicts a service provider connected to two customers that each have subnets that may contain duplicate network addresses. As noted above, multiple internal networks within a highly distributed data processing system may contain duplicate addresses. Service provider 1050 manages networks and applications for multiple customers and stores its data within multi-customer database 1052. Customer 1054 has a network of devices that includes subnet 1056 that connect with the larger network through NAT 1058; customer 1064 has a network of devices that includes subnet 1066 that connect with the larger network through NAT 1068. Duplicate network addresses could appear within subnets 1056 and 1066. In order to provide certain services in a seamless fashion such that both customers can be managed by the service provider as a single logical network, the service provider requires a network management framework that can handle duplicate network addresses.

The network management framework that is described herein can manage multiple networks over which duplicate addresses might appear, e.g., as shown in FIG. 10B, such that the distributed network management framework is operable across multiple NATs. The manner in which the network management is performed is described further below in more detail.

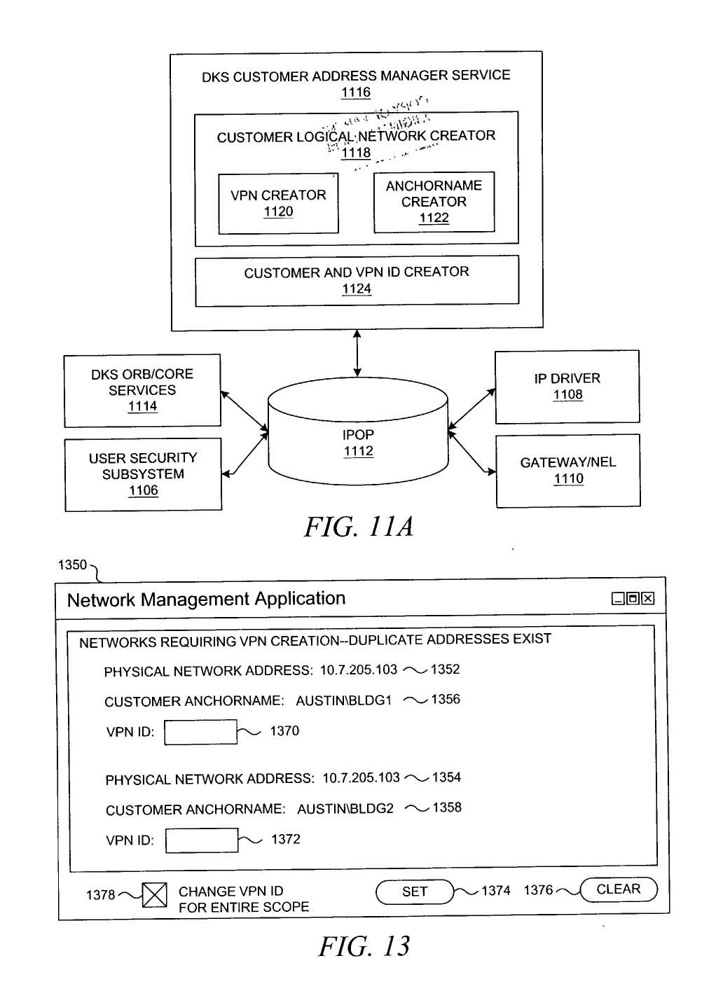

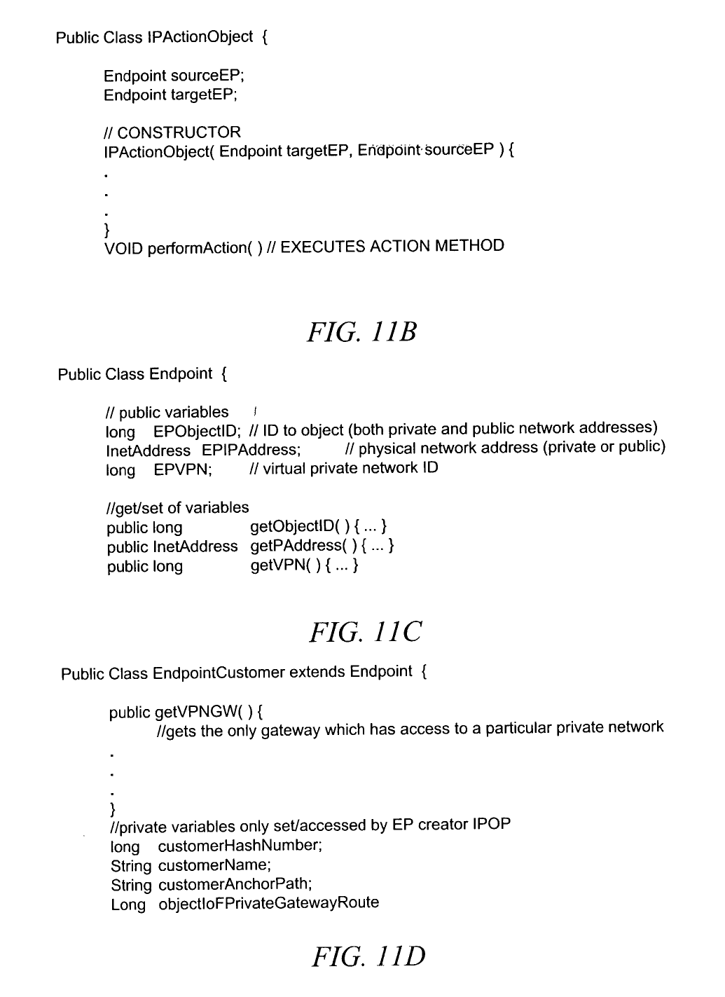

With reference now to FIG. 11A, a block diagram shows a set of components that may be used to implement multi-customer management across multiple networks in which duplicate addresses may be present. FIG. 11A depicts components that are similar to components introduced in other figures above. User security subsystem 1106 provides a user authentication and authorization service, which may be used to verify the identity of users, such as administrators, during a login process and during administrative operations. IP drivers 1108 detect IP objects within an IP network. Gateway/NEL service 1110 provides action object processing within gateways. A persistent repository, such as IPOP database 1112, is updated to contain information about the discovered and monitored IP objects. Other ORB or core services 1114 may also access IPOP database 1112.

Customer address manager service 1116 queries IPOP 1112 during operations that allow an administrator to resolve addressability problems. Customer logical network creator 1118 fetches administrator input about the groupings of physical networks into a logical network, as may be provided by an administrator through an application GUI, such as the GUI shown in FIG. 13. From this input, the various scopes of the physical networks are combined to create a logical scope as previously described above.

VPN creator 1120 fetches administrator input concerning which physical networks belong to which customer. The administrator can provide a name to each physical network collection, which is used by the anchor name creator 1122 to define an anchor name, which is highest level name used to describe a logical network. The final name of each physical network is a combination of the anchor name and the name assigned to each logical network. For example, the name of a logical network consisting of the physical networks 146.5.*.* would be “austin\downtown\secondfloor” comprising the anchorname=“austin” and the name=“downtown\secondfloor.” The anchor name creator supplies a name to the IP Driver subsystem by combining the anchor name, determined from the scope configuration, and the name of the physical network element object from IPOP. Finally, a customer ID creator 1124 uses the collection of IDs used by all customers to generate a new unique customer identifier when required by IPOP; the identifiers are used rather than strings for efficient database searches of large number of network objects. During subsequent operations to map the location of a user to an ORB, customer address manager service 1116 queries may query an active-user database similar to that shown in FIG. 6.

With reference now to FIGS. 11B-11D, some simplified pseudo-code depicts the manner in which action objects and endpoint objects can be implemented in an object-oriented manner. FIG. 11B shows a class for action objects, while FIGS. 11C-11D show classes for endpoint objects.

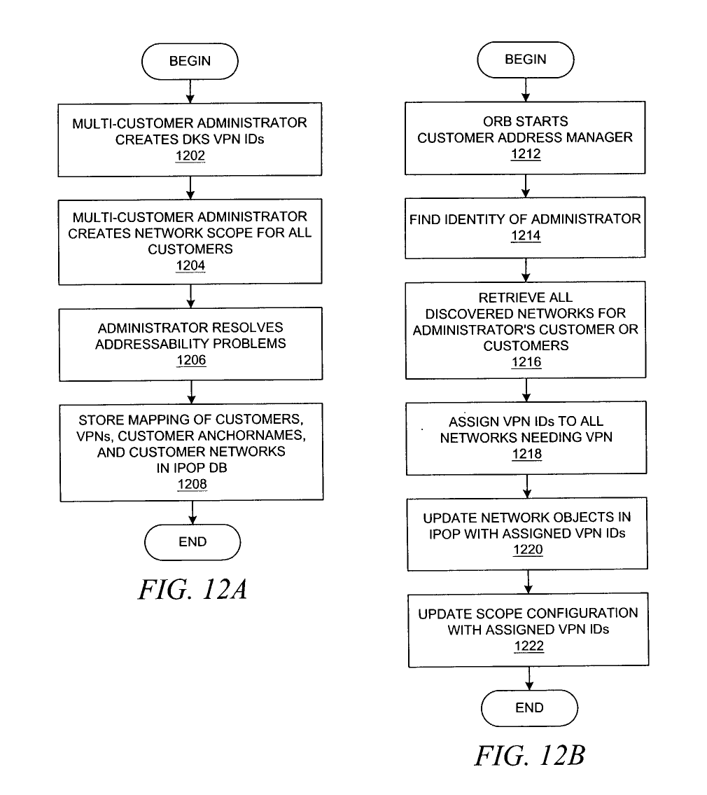

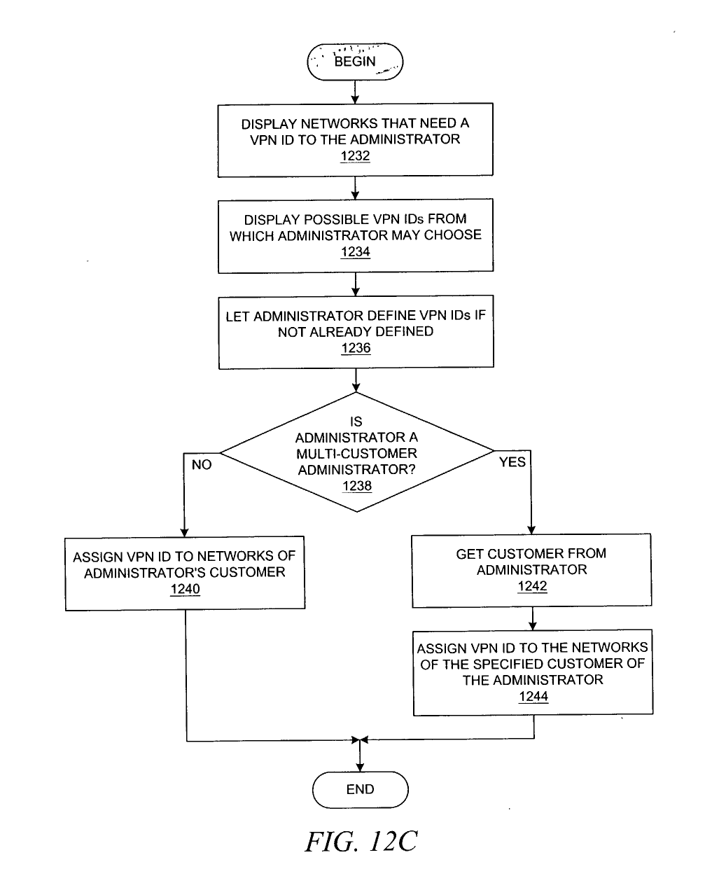

With reference now to FIG. 12A, a flowchart depicts a portion of an initialization process in which a network management system prepares for managing a set of networks with multiple NATs. It is assumed that a network administrator has already performed configuration processes on the network such that configuration information is properly stored where necessary. The process begins when a multi-customer administrator creates DKS VPN IDs during installation (step 1202). For example, after the ORB has started, the ORB starts a Command Line Interface (CLI) Service through which an administrator can issue CLI commands to create VPN IDs within the IPOP database, such as “ipop create VPN” used by customer and VPN ID creator 1124 in order to create a unique customer ID or a unique VPN ID.

The process then continues with the multi-customer administrator creating network scope for one or more customers (step 1204). Multi-customer regions may also be created, which refers to the managing a region that consists of two or more customers for which care has to be taken not to intermix different customer data. At this point, the physical network is discovered via a discovery engine, such as the IP driver service, which performs a discovery process to identify IP objects and stored those in the IPOP persistence storage. For all customer locations, all of the physical networks that have been discovered are displayed to the administrator so that the administrator can conveniently apply names to the discovered objects/networks. In addition, multiple address problems are determined and displayed to the administrator, who is then required to assign a VPN ID to a customer, e.g., by using an application GUI such as that shown in FIG. 13.

Part of the customer scope, i.e. a logical scope consisting of a collection of physical networks as described previously, is the customer anchor name text array, e.g., “ibm\usa\Austin”, the customer name, and a unique customer ID, as created by customer address manager service 1116 in FIG. 11A. The hash number is computed by the customer base text name, e.g., “ibm”, the network addresses, e.g., all subnets of reserved public addresses, and VPN IDs.

The administrator then resolves any outstanding addressability problems (step 1206). For example, a large corporation may have subnets “10.0.0.*” on each floor of a large office. After those have been resolved, then the system stores the mapping of customers, VPN IDs, customer anchor names, and customer networks in the IPOP database (step 1208), and the initialization process is then complete.

With reference now to FIG. 12B, a flowchart depicts further detail of the initialization process in which the administrator resolves addressability problems. FIG. 12B provides more detail for step 1206 shown in FIG. 12A in which an administrator proceeds to resolving identified addressability problems.

The process begins, during the initialization process, as an ORB starts the customer address manager (step 1212). The customer address manager then finds the identity of the administrator that is performing various address management functions through a network management application (step 1214). At this point, the identity of the network administrator may be used to ensure than the administrator has the proper authorization parameters. However, for the sake of explanation, it may be assumed that an administrator with multi-customer rights has access to the GUI to create VPNs for multiple customers, i.e. it may be assumed that an administrator has the proper authorization for working with the data from multiple customers. The multi-customer administrator uses the administrator GUI shown in FIG. 13, which uses the customer address manager, to display all of the discovered networks for the administrator's customer or customers (step 1216).

After retrieving this information, the customer address manager may then allow the administrator to assign VPN IDs to those networks for which it can be determined that the networks have an addressability problem (step 1218). The assigned VPN IDs are then stored as updated information within the network objects within IPOP (step 1220). The scope information is also updated with a VPN ID (step 1222); initially, many scopes are defined as “VPN =0”, which means no VPN address. The VPN ID creator ensures that unique VPN IDs are created such that duplicate addresses can exist within a VPN that has an assigned VPN ID. This portion of the initialization process is then complete. The manner in which the administrator assigns VPN IDs is explained in more detail with respect to FIG. 12C.

In order to determine which networks require a VPN ID, the customer address manager sorts through all of the network addresses, looking for problematic addresses. For example, a set of 255 public addresses, such as “10.0.0.*”, are reserved for local network purposes. Hence, even if two networks within the network management system do not have colliding local network addresses, the potential for future collisions exists.

With reference now to FIG. 12C, a flowchart depicts further detail of the process in which the administrator assigns VPN IDs. FIG. 12C provides more detail for step 1218 shown in FIG. 12B. The process begins by displaying those networks have been determined to need a VPN ID assigned since a duplicate address exists, as determined with respect to step 1218 above, to the current administrator (step 1232). The customer address manager then displays a list of possible VPN IDs from which the administrator may choose (step 1234), and the administrator is able to define VPN IDs as necessary if not already defined (step 1236). VPN IDs could have been previously defined through the configuration service, most likely during installation. However, at configuration time, the networks have not yet been discovered, so it is not possible for the system to know if and where duplicate addresses exist. While the figures are described with respect to the actions of a single administrator, a highly distributed system has a collection of administrators that are typically not in one location. Hence, one of goals of the DKS management framework is to detect errors and allow the administrators to have input into the manner in which the errors should be corrected.

A determination is then made as to whether the administrator is a multi-customer administrator (step 1238). If not, then the VPN ID that has been chosen by the administrator can be assigned to the networks of the administrator's customer (step 1240). If the administrator is a multi-customer administrator, then the customer address manager must get a specific customer from the administrator (step 1242), and the chosen VPN ID is assigned to the specified customer (step 1244). This portion of the initialization process is then complete. After these initialization steps, the administrator has an overall addressing scheme that should be coherent. The IP addresses, VPN IDs, and other information, when taken together, provides a scheme for unique identifiers that the management system can use to manage the devices throughout the system.

With reference now to FIG. 13, a figure depicts a graphical user interface window that may be used by a network or system administrator to set monitoring parameters for resolving address collisions. Window 1350 is a dialog box that is associated with a network management application; a system or network administrator is required to create or enter VPN IDs to resolve duplicate addresses that have been detected, such as physical network addresses 1352 and 1354. An administrator could also invoke the application on a regular basis when necessary, or it could be invoked automatically by the network management system when address collisions are detected. “Set” button 1374 and “Clear” button 1376 allow the administrator to store the specified values or to clear the specified parameters. Checkbox 1378 allows an administrator to quickly change the VPN ID for an entire physical scope indicated within window 1350.

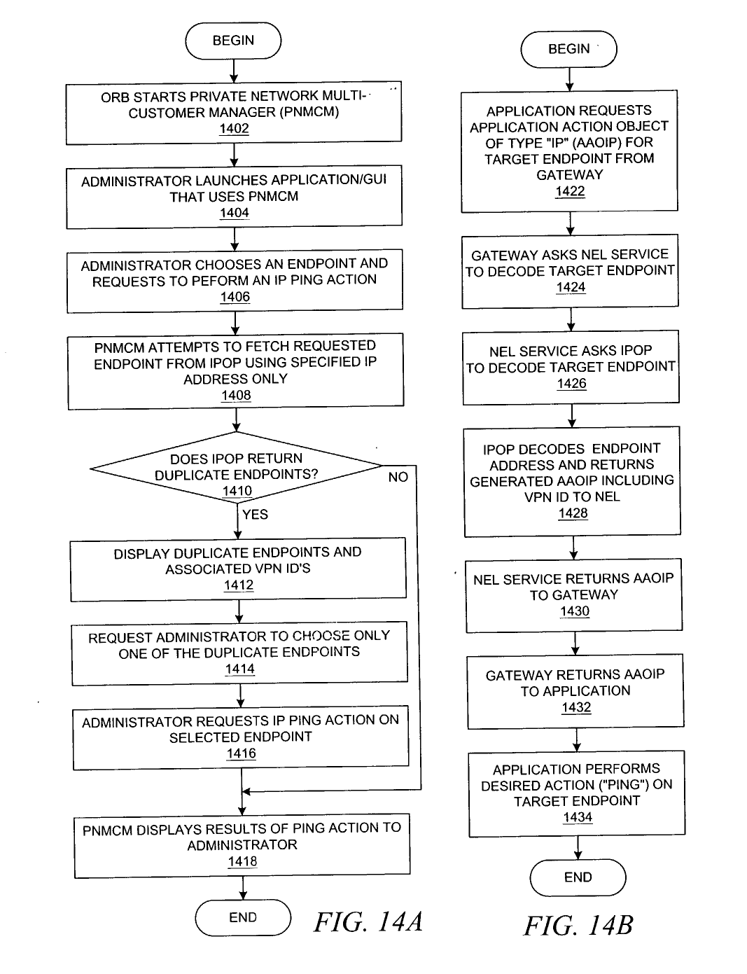

FIGS. 14A-14B depict examples of processes that may be performed by the network management system after system configuration/initialization when an administrator is using a network management application to perform a certain operation, such as a simple IP “Ping” command as shown in the example. While the example shows a simple IP “Ping” action, a more complex action could include a software distribution application that installs software on endpoints throughout the distributed data processing system.

With reference now to FIG. 14A, a flowchart shows the overall process for performing an IP “Ping” within a multi-customer, distributed data processing system containing multiple private networks. The process begins when an ORB starts a private network multi-customer manager (PNMCM) that is used by the system to perform certain actions, such as requesting an IP “Ping” (step 1402). The user of the application, which in this case is a network or system administrator for a particular customer, launches an application associated with the PNMCM (step 1404). Within the application, the administrator chooses an endpoint and requests an IP “Ping” action, most likely from hitting a “Ping” button within the GUI (step 1406).

The PNMCM manager attempts to fetch the requested endpoint from the IPOP database using only the IP address as specified or selected by an administrator within an application GUI (step 1408). A determination is then made as to whether IPOP returns duplicate endpoints (step 1410). If not, then the process branches to show the results of the requested “Ping” action.

If there is a collision among duplicate IP addresses, they are displayed to the administrator along with the previously associated VPN IDs that help to uniquely identify the endpoints (step 1412). The administrator is requested to choose only one of the duplicate endpoints (step 1414), and after choosing one, the administrator may request to perform the “Ping” action on the selected endpoint (step 1416). The PNMCM displays the results of the “Ping” action to the administrator (step 1418), and the process is complete.

With respect to FIG. 14B, a flowchart depicts a process for obtaining and using an application action object (AAO) within the network management system of the present invention. An application action object is a class of objects that extends an action object class in a manner that is appropriate for a particular application.

The process begins when an application requests, from the gateway service, an application action object (AAO) for a “Ping” action (AAOIP) against a target endpoint (step 1422). The process assumes that the administrator has already chosen the source and target endpoints through some type GUI within a network management application.

The gateway service asks the NEL service to decode the target endpoint from the request (step 1424). As noted previously, one of the primary roles of the NEL service is to support the requests from applications for routes, as explained above with respect to FIG. 3. The NEL service then asks the IPOP service to decode the endpoint object (step 1426). Assuming that the processing has been successfully accomplished, IPOP returns an appropriate AAOIP object to the NEL service, including VPN ID if necessary (step 1428), and the NEL service returns the AAOIP object to the gateway service (step 1430). The gateway service then returns the AAOIP object to the application (step 1432). The application then performs the desired action (step 1434), such as an IP “Ping”, and the process is complete.

The description of FIGS. 11A-14B explain a methodology for configuring the network management framework to manage the networks of multiple customers, which may have conflicting physical network addresses; by employing scopes and anchors, the conflicts can be resolved. As described above with respect to FIGS. 5A-5C, when a network is discovered, it is associated with a particular scope, and each scope relates to an anchor. Scope configuration is important to the proper operation of the IP drivers because IP drivers assume that there are no overlaps in the drivers' scopes. Since there should be no overlaps, every IP driver has complete control over the objects within its scope. When IP mapper is informed that a new network has been discovered, it uses the scope associated with the network to determine with which anchor, i.e. customer, the newly discovered network should be associated, and the appropriate updates are also made within the topology database.

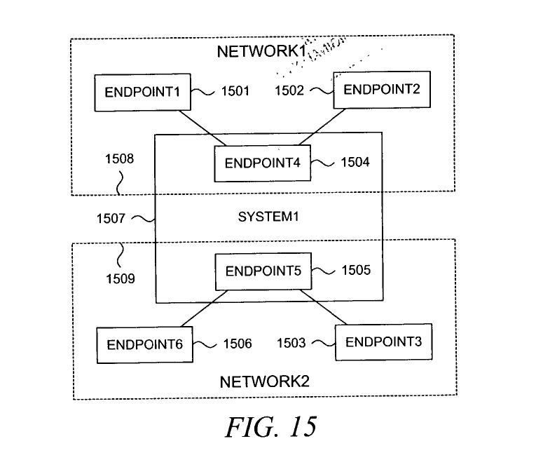

Assuming that an administrative user has the proper security access, the administrative user should have the ability to modify various management aspects of scopes and anchors. However, scope manipulation can be quite complex. For example, an administrative user may incorrectly attempt to change the manner in which a set of endpoints is managed such that a conflict between scopes arises. Hence, the network management framework needs to be able to handle dynamic changes in scope while monitoring for errors such as scope overlap. In addition, the network management framework should enable dynamic changes in administrative responsibility over different scopes and also enable security monitoring for such administrative changes. These types of changes are described in a high-level manner with respect to FIG. 15.

With reference now to FIG. 15, a block diagram depicts a logical organization of network-related objects that may be managed within different scopes on behalf of a plurality of customers whose physical networks are being administered using the network management framework of the present invention. After a discovery process, a distributed data processing system is determined to contain physical devices that may be represented by the network-related objects shown in FIG. 15: endpoints 1501-1506 have been dynamically discovered; endpoint 1504 and endpoint 1505 reside within system 1507; endpoint 1501, endpoint 1502, and endpoint 1504 reside within network 1508, while endpoint 1503, endpoint 1505, and endpoint 1506 reside within network 1509. In this example, system 1507 may be a router.

At some point in time during the initial phases of configuring a distributed data processing system, the physical networks of the distributed data processing system may have been discovered, but the physical networks would not yet have been associated or assigned to logical networks on behalf of customers. In this case, all of the network-related objects 1501-1509 are managed using a single IP driver within a single scope; for instance, this initial scope may be initially assigned to a management entity, i.e. the service provider that is managing the distributed data processing system on behalf of a set of customers.

At some subsequent point in time, an administrative user may desire to dynamically segment the distributed data processing system into two customer scopes; the scope of the initial IP driver is changed to include only the endpoints within network 1508, and another IP driver is introduced to be responsible for monitoring the endpoints within network 1509. It is assumed that the administrative user has appropriate security access to an administrative application that provides access to a Distributed IP Driver Change Manager (DICM) for initiating such management actions; the DICM may be a component within the IP drivers or may be a separate service that coordinates these types of management actions with the IP drivers.

For this example, the DICM would perform the following deletion actions: endpoint 1503, endpoint 1505, and endpoint 1506 would be deleted from the endpoint table is associated with the initial IP driver in the IPOP database; references to endpoint 1505 would be deleted from the system table that is associated with system 1507 in the IPOP database; and references to endpoint 1505 would be deleted from the network table that is associated with network 1509 in the IPOP database.

Although not shown in FIG. 4, other tables may be stored within the IPOP database for use in these operations to change the configuration of the IP drivers. In this case, the DICM moves the network-related objects to temporary tables: the system object for system 1507 is moved to an orphan system table in the IPOP database; the network object for network 1509 is moved to an orphan network table in the IPOP database; and the endpoint objects for endpoint 1503, endpoint 1505, and endpoint 1506 are moved to an orphan endpoint table in the IPOP database. All of the objects within the orphan object tables are then marked as seeds to be used by the newly introduced IP driver upon its startup to perform an abbreviated, more efficient, discovery process. Rather than configuring the new IP driver instance to physically discover its assigned network of devices, the new IP driver instance can be configured to perform discovery using the objects in IPOP that have been marked as IPOP seeds. When the new IP driver is started on its ORB for the first time, the seeds are used to create new IPOP objects and topology objects, including the relations between objects, with new object IDs and other non-physical network-related data. After that point in time, any management operations that need to be performed with the objects through the new IP driver would require appropriate security access as configured for the new IP driver.

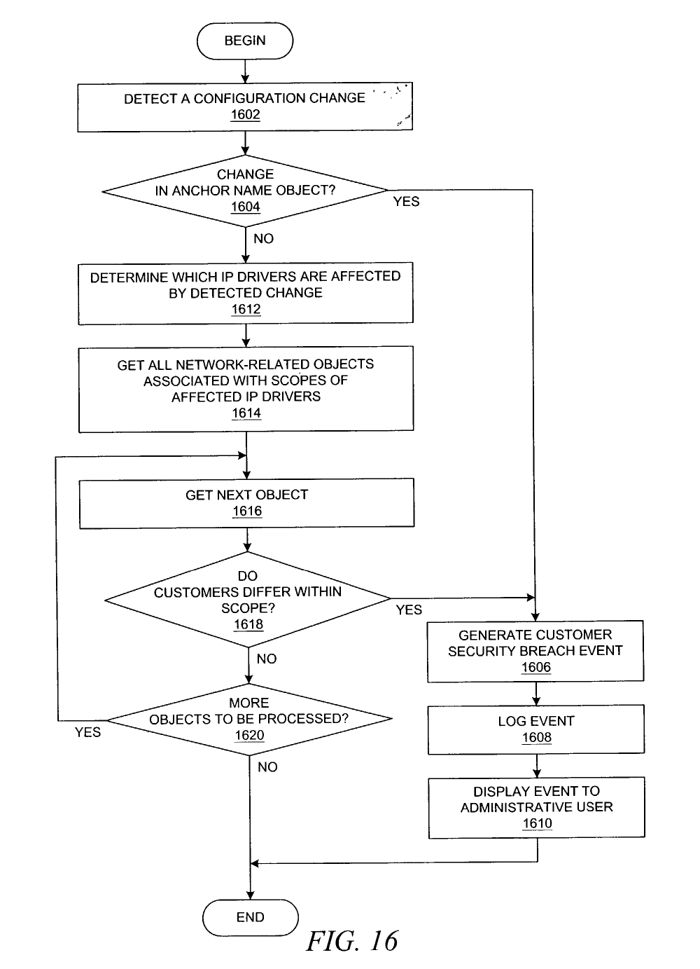

At this point in time, the distributed data processing system can be viewed as two logical networks that are being managed by two IP drivers on behalf of a single management entity. However, an administrative user may then assign each of the logical networks to a customer such that the logical networks are managed on behalf of two customers. From that point on, any administrator-initiated operations would require the appropriate security access as configured for those customers. Any attempts to change the scopes of the logical networks or to create a new IP driver across customer lines would generate a security event for review by an administrative user, which is explained in more detail with respect to FIG. 16.

With reference now to FIG. 16, a flowchart depicts a process for handling certain types of scope-related events. The process begins with the Distributed IP Driver Change Manager (DICM) detecting a configuration change that affects the configuration of the current scopes or introduces a new IP driver (step 1602). The DICM may register multiple object listeners throughout the distributed data processing system for these purposes.

In response to receiving an event, the DICM determines whether a change has been detected in an anchor name object (step 1604). If so, then the DICM generates a customer security breach event (step 1606), which causes a network console application to log the event (step 1608) and display the event within a GUI for review by an administrative user (step 1610), after which the process is considered complete. Because a change in anchor name is equivalent to moving a logical network between customers, the change is critical and needs to be verified. The administrative user can then determine whether the event was actually generated by an administrator-initiated action. In this manner, administrative operations are subject to a feedback loop that automatically detects certain changes that affect the customer to which a network-related object is assigned. In a multi-customer environment with many administrative users, the administrative user that approves of the change may be in a completely different management office than the administrative user that initiated the event.

If the event is not a change in the anchor name, then a more detailed test is performed to determine whether the change has resulted in a change in scope that affects the customer to which a network-related object is assigned. A determination is made as to which IP drivers are affected by the detected change (step 1612), and for each scope assigned to the determined IP drivers, all network-related objects (networks, systems, and endpoints) are retrieved (step 1614). The DICM then loops through the retrieved objects by getting a next object (step 1616) and determining whether the customer associated with the object differs from the other objects within the same scope (step 1618). If so, there has been some type of breach in security related to the various customers because a single scope can only include objects assigned to a single customer. Hence, the DICM again generates a customer security breach event at step 1606, which is handled again at steps 1610 and 1612. Otherwise, if there are more objects to be processed (step 1620), then the DICM continues to loop through those objects to determine whether there has been a customer security breach event.

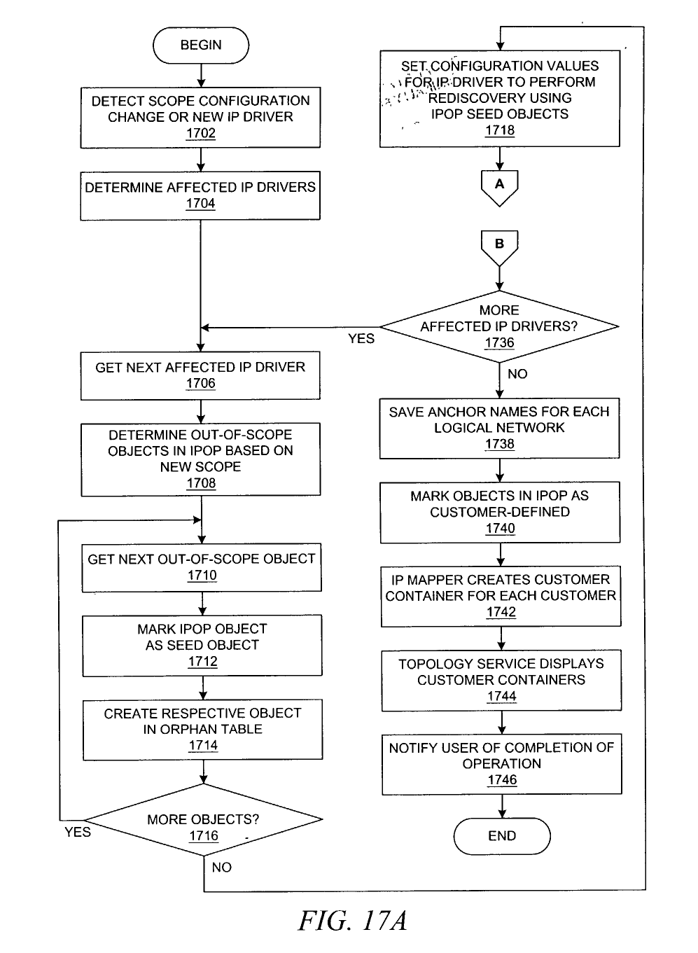

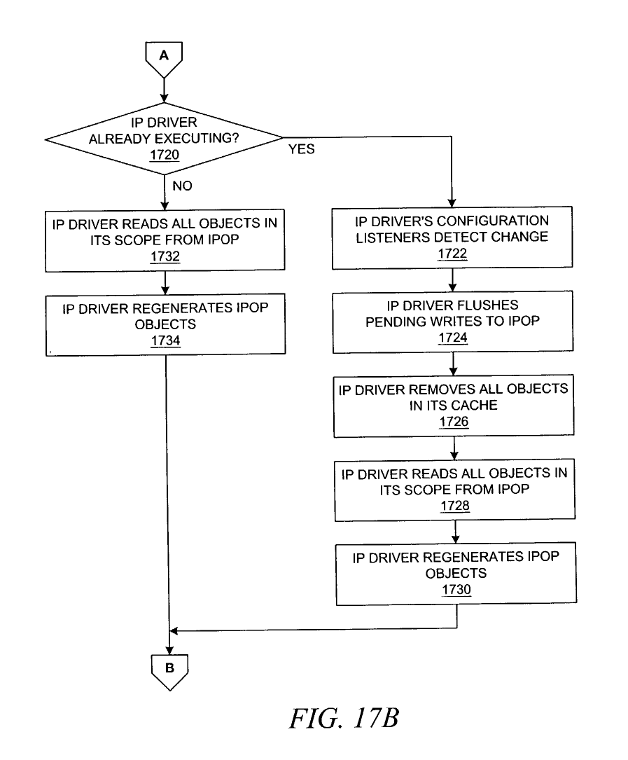

With reference now to FIG. 17A-17B, a pair of flowcharts depicts a process for relocating network-related objects based on a change of scope initiated by an administrator or for configuring multiple customers within a distributed data processing system. In a manner similar to that described with respect to FIG. 15, a multicustomer administrator wants to segment a single distributed data processing system into a multi-customer environment. An administrative user changes the scope configuration pertaining to scope or IP driver by defining a new scope to encompass a certain physical network, after which the topology service will be able to display a network object or icon for the newly introduced customer. The change may be effected through a network management console application at the direction of the administrative user.

The process begins by detecting that a new IP driver has been started or that a change has been made in the configuration of one of the existing scopes (step 1702). All IP drivers that are affected by the change are determined (step 1704), and the process then loops through the scopes of the affected IP drivers.

A first or next affected IP driver is identified (step 1706), depending upon the iteration in the loop through the IP drivers, and any objects within one or more scopes of the affected IP driver are examined to determine which objects are now out-of-scope for the affected IP driver, i.e. outside of the scopes assigned to the affected IP driver, based on the newly defined IP driver's scope(s) or the change in the configuration of one or more scopes (step 1708).

A first or next out-of-scope object is obtained (step 1710), depending upon the iteration in the loop through the out-of-scope objects, and the out-of-scope object is marked as a seed object (step 1712), which will cause the object to be subsequently processed in a special manner when the new IP driver performs its rediscovery process. The out-of-scope object is then moved to an orphan object table in the IPOP database (step 1714) corresponding to its type of network-related object, i.e. network object, system object, or endpoint object. A determination is then made as to whether there are additional out-of-scope objects to be processed (step 1716). If so, then the process branches back to step 1710 to process another out-of-scope object. If all of the out-of-scope objects have been processed, then the rediscovery process may begin.

Appropriate configuration values are set for the IP driver that is responsible for the newly configured scope to indicate that the IP driver is to perform a rediscovery process on the seed objects in the IPOP database (step 1718). A determination is then made as to whether the IP driver is already executing or whether it is being initialized (step 1720).

If the IP driver was already executing, then the processing within the IP driver differs as it performs certain actions in anticipation of the rediscovery process. As a first step, the configuration listeners for the IP driver detect a change in the IP driver's configuration (step 1722), most likely in conjunction with notification from a configuration service. In response, the IP driver flushes any write operations that are pending for the IPOP database (step 1724) to ensure that those updates are reflected in the IPOP database before the IP driver begins performing its monitoring and discovery duties under a new configuration. For similar reasons, the IP driver flushes its cache of IPOP objects (step 1726). The IP driver then reads all objects defined to be within its scope (which may be a newly configured scope) from the IPOP database (step 1728), and for any of those objects that are marked as seed objects, the IP driver performs a rediscovery process in which it creates new IPOP objects for the seed objects (step 1730). In the rediscovery process, the IP driver regenerates non-physical network information using newly generated identifiers, such as unique numbers that are used by the DKS services, object IDs, anchor names that may have changed for the scope, and relationships between with other objects. The process then branches as the processing of this IP driver within the IP driver loop is complete.

If the IP driver was not already executing at step 1720, then the IP driver is newly initialized, which it may determine by reading a configuration value that directs the IP driver to perform a rediscovery process using IPOP seeds rather than performing a full discovery process on the networks within its scopes. The rediscovery process for the newly initialized IP driver is similar to that described above. The IP driver reads all objects defined to be within its scope from the IPOP database (step 1730), and for any of those objects that are marked as seed objects, the IP driver performs a rediscovery process in which it creates new IPOP objects for the seed objects (step 1732). The process then branches as the processing of this IP driver within the IP driver loop is complete.

A determination is then made as to whether there are other affected IP drivers (step 1736), and if so, then the process branches back to step 1706 to process additional scopes. If there are no other affected IP drivers, then additional configuration processing can be performed as part of the operation of the network management console application that initiated the change in scope. For example, if an administrative user was defining a new logical network within the distributed data processing system, then the anchor name that was entered by the user, such as through an application window similar to that shown in FIG. 13, is associated with all of the objects in a newly defined or newly configured logical network (step 1738). In addition, all of the affected objects in the IPOP database could be indicated as being “customer-defined” (step 1740). This indication assists in determining whether there has been an unwarranted modification of an anchor name or customer association as described above with respect to FIG. 16.

In addition, the IP mapper creates a customer container object for each defined or reconfigured customer (step 1742) so that the topology service can display the customer objects (step 1744), and the administrator is notified that the operation is complete (step 1746).

As noted previously, given a scenario in which a multi-customer service provider is operating an integrated network management system for multiple customers, it is likely that many individuals will be assigned to manage different regions and different groups of devices. In addition, these individuals may have different duties within geographically dispersed portions of the network, such as various customer sites, and these individuals may belong to many different organizational groups, either within the service provider's organization or within one of the customer's organization. In a highly distributed system comprising on the order of a million devices, the task of authenticating and authorizing the administrative actions of many individuals per customer, per region, per device, etc., becomes quite complex.

FIGS. 6-7D depict the restriction of administrative user access to various operations and functionality within the network management framework, while FIGS. 8A-14B depict a couple of administrative operations that may be performed within the network management framework, thereby showing some aspects of the manner in which the components within the DKS network management framework operate. FIGS. 15-17B depict a methodology for allowing an administrator for a multi-customer service provider to configure portions of the network management framework for operating on the networks of more than one customer.

The remaining figures provide more detail concerning the manner in which the DKS framework can be configured to achieve certain benefits to solve certain locational issues within a large, highly distributed data processing system. More specifically, the network management framework of the present invention facilitates the management of logical networks by automatically generating security attributes for resources according to geographic location data.

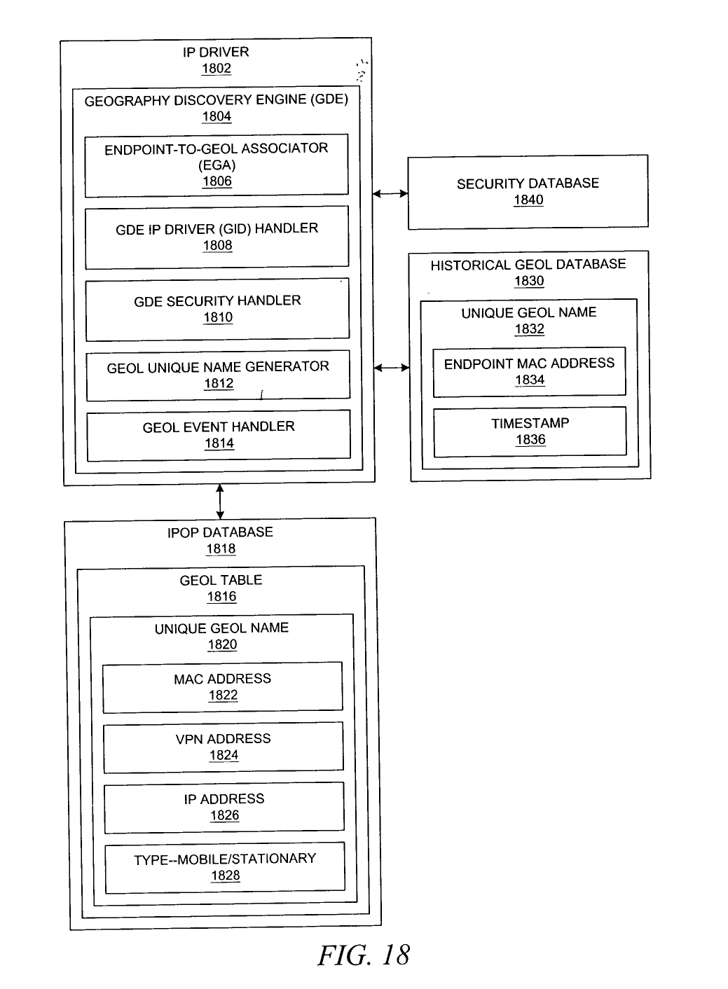

With reference now to FIG. 18, a block diagram depicts components within the network management framework for generating and managing geographic location data associated with resources within a distributed data processing system. Whereas FIG. 5A depicts components associated with the distributed IP driver subsystem, FIG. 18 shows more detail for associated components that facilitate management of geographic location data, hereinafter also termed GEOL data. The DKS network management framework uses a distributed IP driver subsystem to discover and monitor endpoints; IP driver 1802 comprises geography discovery engine (GDE) 1804 that comprises several components for generating and managing GEOL data within an IP driver.

Endpoint-to-GEOL associator (EGA) 1806 provides functionality for associating endpoints with GEOL data. As is described in more detail further below, the GEOL data for an endpoint is generated with respect to known GEOL data previously associated with a statically located router through which network traffic is directed to an endpoint. For example, EGA 1806 determines GEOL data associated with an endpoint by retrieving GEOL data of the endpoint's router in any of the following manners: by retrieving GEOL data associated with the global positioning system (GPS) data associated with its router; by getting GEOL data within configuration data associated with the router through a configuration service; by obtaining GEOL data associated with the GPS data of a nearest cell router, assuming that the endpoint is collocated within a mobile-phone-type device; by obtaining GEOL data associated with the GPS data of a network address generator, assuming that a network address is generated for the endpoint's device in a dynamic manner; or by generating GEOL data in some other similar manner. In addition, EGA 1806 is able to determine whether or not the endpoint has moved based on its current GEOL data and any historic GEOL data associated with the endpoint.

GDE IP driver (GID) handler 1808 provides functionality for managing GEOL data associated with an endpoint with respect to a particular IP driver via the IPOP database. For example, GID handler 1808 can determine the router associated with an endpoint and whether or not the endpoint is stationary or mobile. GID handler 1808 can obtain the IP address, MAC address, or VPN address associated with an endpoint's GEOL data from the IPOP database.

It should be noted that although the MAC address is used within the exemplary embodiments discussed below, other types of unique network hardware identifiers may be also be used, assuming the network hardware identifiers are generated or stored by the network hardware and are globally unique across all network devices within the distributed data processing system.

GDE security handler 1810 provides authorization functionality for an endpoint with respect to its GEOL data, such as creating security attributes for an endpoint using the endpoint's GEOL data. In addition, GDE security handler 1810 can determine whether a principal, such as an administrative user, is authorized to access this particular endpoint. GEOL unique name generator 1812 provides functionality for combining the GEOL data associated with an endpoint with other name information associated with the endpoint within a name space, such as an anchor name.

GEOL event handler 1814 examines MAC addresses associated with the discovery and monitoring operations of the IP driver to determine when a device is a newly discovered device, when a device has disappeared, or when a device has reappeared. GEOL event handler 1814 may process events generated by the discovery controller within the IP driver in response to the discovery controller determining that a MAC address is a newly discovered device or a known MAC address of a device that has moved.

GEOL table 1816 within IPOP database 1818 contains unique GEOL names 1820 and several data items associated with each GEOL name, such as MAC address 1822, VPN address 1824, IP address 1826, and mobile/stationary flag 1828 which may be managed by GID handler 1808. GEOL historical database 1830 contains GEOL data previously associated with mobile endpoints for tracking endpoints, such as GEOL name 1832 with which an endpoint with MAC address 1834 was associated at a given data time as specified by archived timestamp 1836; GEOL data within GEOL historical database 1830 may be managed by EGA 1806.

As GDE security handler 1810 generates security attributes for endpoints as determined by an endpoint's GEOL data, the security data may be stored within a security-related database, such as security database 1840, which may be maintained by the DSC manager as described above with respect to FIG. 6.

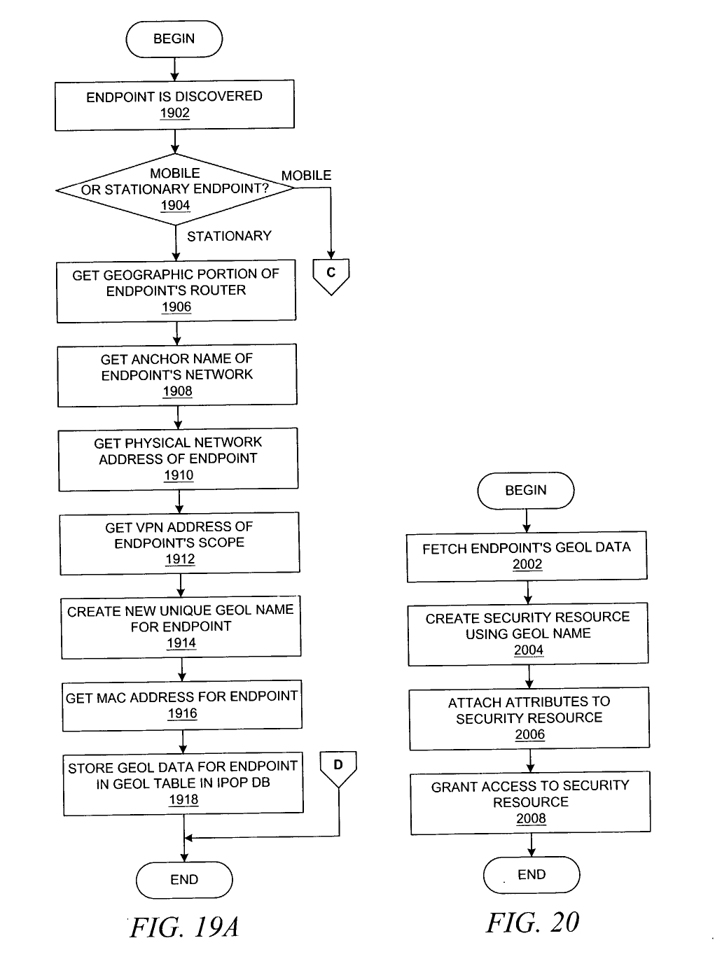

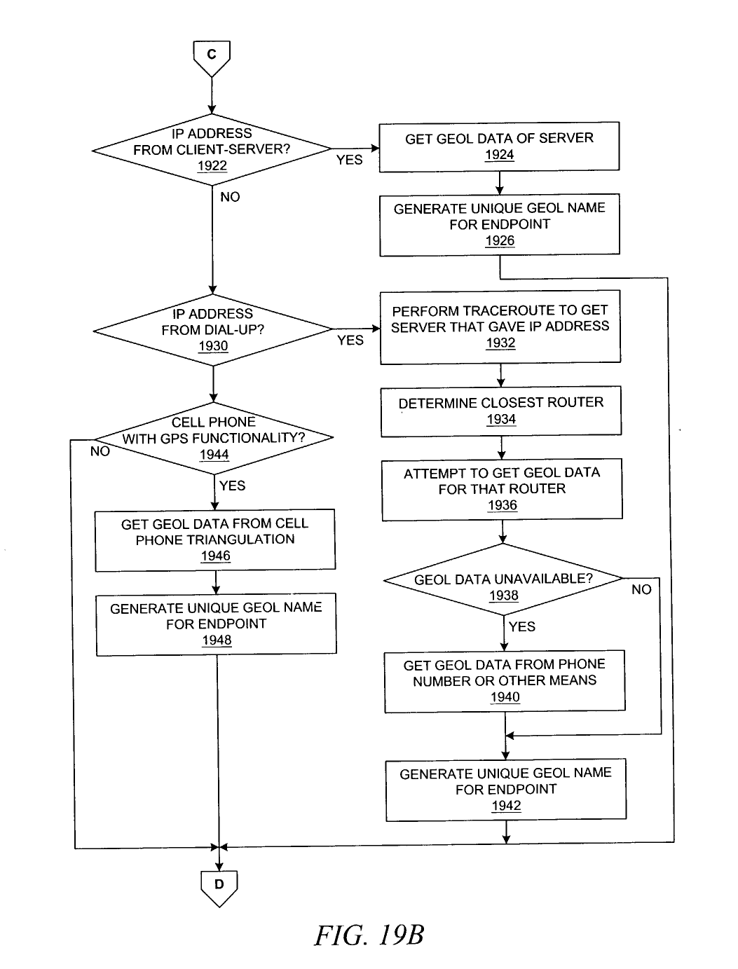

With reference now to FIGS. 19A-19B, a pair of flowcharts depict a process by which the geographical location (GEOL) data is generated and associated with an endpoint. When an endpoint is discovered, the DKS network management framework performs many actions, such as updating an active topology display as briefly shown in FIGS. 8A-9B. In conjunction with these other activities, the DKS management framework creates GEOL data for a variety of purposes, some of which are shown in more detail below. Using the components shown in FIG. 18, an IP driver generates and stores GEOL data that is accessed and used during these other activities.

The process begins when an endpoint is discovered (step 1902), and a determination is made as to whether the endpoint is a mobile endpoint or a stationary endpoint (step 1904). This determination can be done by interrogating SNMP data, which contains an indication of whether the address is a mobile-type address or stationary-type address; the discovery/monitoring processes can find or monitor this data for changes. Alternatively, the BIOS or operating system of the endpoint device can be interrogate to obtain data that indicates whether the endpoint device is a mobile device. For example, an indication that the endpoint device is a particular type of notebook computer would inherently indicate that the device is a mobile device, whereas an indication that the endpoint device is a particular type of desktop computer inherently indicates that the device is a stationary device. Depending on this determination, the process proceeds to generate the GEOL data for the discovered endpoint in an appropriate manner. The following description merely contains preferred examples of the manner in which mobile endpoints are processed; other cases could be included in the present invention as necessary to handle different types of mobile systems.

If the endpoint is a stationary endpoint, then the endpoint is inherently associated with a stationary router, which already has GEOL data that has been defined or configured by an administrative user and which is used during the generation of a unique GEOL name for the endpoint. Prior to generating the unique GEOL name for the endpoint, though, the unique GEOL name generator obtains several data items for the discovered endpoint. The geographic portion of the associated router's GEOL data is obtained (step 1906). The discovered endpoint must lie within a network, so the anchor name of the anchor with which the endpoint's network is associated is then obtained (step 1908), which essentially provides geographic data that has been supplied by a customer; it should be noted that the anchor name of the network may be the same as the geographic portion of the GEOL data for the associated router determined in step 1906. The physical network address of the endpoint has just been discovered by the IP driver, thereby providing a physical network address (step 1910), and the VPN address of the scope in which the endpoint lies is also retrieved (step 1912). Using these data items, the unique GEOL name generator creates a new unique GEOL name for the discovered endpoint (step 1914). The GEOL discovery engine obtains the MAC address for the endpoint from the IPOP database (step 1916), and the newly generated GEOL data for the discovered endpoint is associated with the MAC address and then stored within the GEOL table within the IPOP database (step 1918), after which the process is complete.

If the endpoint is determined to be a mobile endpoint at step 1904, then the following steps are performed in order to generate GEOL data for the newly discovered endpoint. Given that the endpoint is a mobile endpoint, the system attempts to obtain information about the endpoint's physical location in relation to other endpoints and systems within the distributed data processing system. For example, a search can be made within the IPOP database for a router that is physically closest to the newly discovered endpoint's location. After obtaining the closest router, GEOL data is generated for the newly discovered endpoint so as to place the newly discovered endpoint appropriately within the GEOL naming scheme, as is described in more detail below.

A determination is made as to whether the IP address of the newly discovered endpoint was dynamically assigned through a client/server mechanism, such as the DHCP protocol (step 1922). If so, then it is likely that the DHCP server is an intranet that is managing the newly discovered endpoint, such as an intranet within an e-commerce Web site. Hence, the GEOL data of the DHCP server is obtained (step 1924), and a unique GEOL name is generated for the endpoint (step 1926) in a manner similar to that described above in steps 1906-1918, after which the process is complete.

If the determination at step 1922 is negative, then a determination is made as to whether the IP address of the newly discovered endpoint was obtained through a dialup-type mechanism (step 1930), such as may be used with an Internet service provider (ISP) with a DSL, PPP, or PPPOE dialup connection. If so, then a “traceroute” command can be performed from the endpoint to the server which generated the IP address on behalf of its client, i.e. the newly discovered endpoint (step 1932). Using the information generated by the “traceroute” operation, a determination is made of the router that is physically closest to the determined router (step 1934), and an attempt is made to get the GEOL data for this router (step 1936). A determination is made as to whether or not the GEOL data for the router is available (step 1938). If it is not available, then the geographical data that is needed for forming the unique GEOL name is obtained by other means, such as using geographic information that would be associated with the telephone number that was used to establish the client connection, which can be obtained through the telephone network or the local telephone service provider; in other cases, the physical address of the client-side device of a PPP, PPPoE, or DSL connection can be obtained through database records of a service provider (step 1940). A unique GEOL name is then generated for the endpoint (step 1942) in a manner similar to that described above in steps 1906-1918, after which the process is complete.

If the determination at step 1930 is negative, then a determination is made as to whether the newly discovered endpoint is a mobile/cell phone (step 1944), which can be determined through the phone system. If so, then geographical data can be obtained for the mobile endpoint through the phone system by relying on the fact that mobile phone service providers are required to be able to determine the physical location of an active mobile phone within a certain accuracy in order to be able to locate emergency calls (step 1946). The geographic location may be determined within the phone system in a variety of ways, such as by using GPS data provided by a mobile phone device or by using triangulation techniques with the cell towers. A unique GEOL name is then generated for the endpoint (step 1948) in a manner similar to that described above in steps 1906-1918, after which the process is complete.

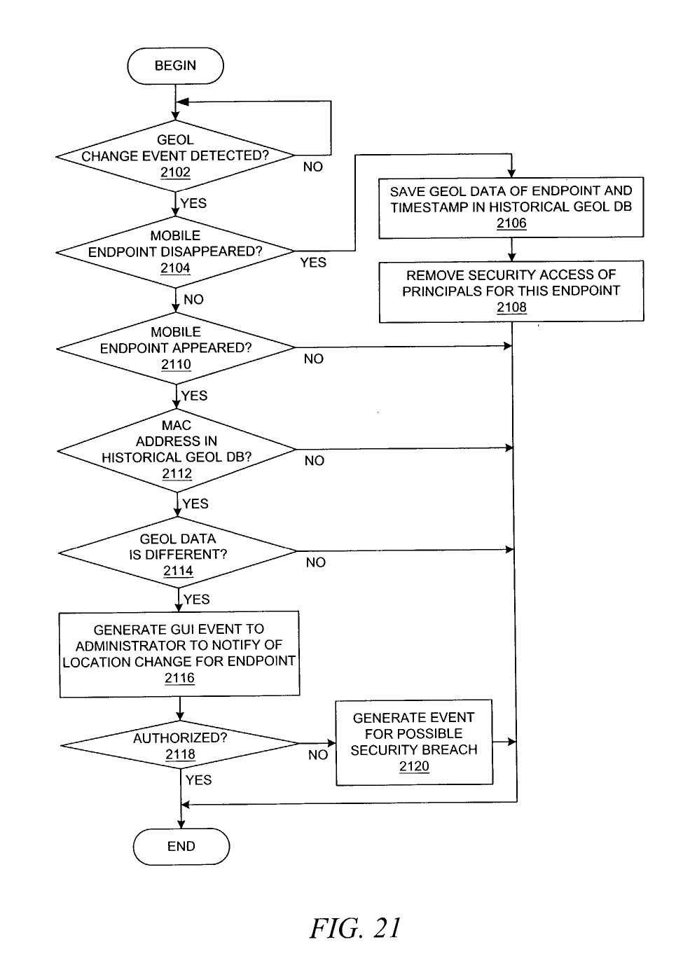

The flowchart depicted in FIGS. 19A-19B shows the generation of GEOL data, which is then used to associate security attributes with an endpoint in conjunction with the endpoint's GEOL data, as shown in FIG. 20. The flowchart in FIG. 21 describes a manner in which the security attributes can be used for an exemplary operation.

With reference now to FIG. 20, a flowchart depicts a process for generating security resources/attributes to be associated with an endpoint in conjunction with the endpoint's GEOL data. The process begins by fetching the GEOL data associated with an endpoint from the GEOL table in the IPOP database (step 2002); a security resource is created in the security subsystem using the unique GEOL name (step 2004). The attributes of the endpoint, such as IP address, MAC address, location, customer name from the associated anchor name, are then attached to the security resource (step 2006). By associating these attributes with a security resource, a filter can easily be applied by an administrative application to find security resources with common attributes for network-related actions on groups of endpoints. In a manner similar to that shown in FIGS. 7C-7D, the GDE security handler loops through the persons, i.e. principals, and/or the roles, i.e. groups of principals, that already have security access with respect to the location of the endpoint and then grants access to the new security resource, i.e. endpoint (step 2008). In this manner, various entities and/or users are granted access to the newly discovered endpoint based on GEOL data; thereafter, access to the newly discovered endpoint can be restricted based on geographic location if desired.

With reference now to FIGS. 21A-21B, a pair of a flowcharts depict a process for detecting movement of endpoints from one geographic location to another geographic location. The process shown in FIGS. 21A-21B assumes that a network of endpoints has already been discovered and that the endpoints are being monitored.

The process begins by determining whether the GEOL event manager within an IP driver has detected a GEOL change event in which a mobile endpoint has either disappeared or reappeared within the distributed data processing system (step 2102). If nothing has been detected, then the process simply cycles as it waits for an event.

If a GEOL-related event is detected, then a determination is made as to whether the event is related to a mobile endpoint disappearing from the network (step 2104). For example, the monitored status of an endpoint may reflect that the endpoint's system has failed or merely that the endpoint is no longer responding to status polls. In any case, the GEOL data that had been associated with the endpoint in the IPOP database is saved to the historical GEOL database along with a timestamp showing the date and time at which the endpoint was determined to have disappeared from the network (step 2106). In a manner opposite to that of step 2008, the GDE security handler loops through the persons, i.e. principals, and/or the roles, i.e. groups of principals, that have security access with respect to the location of the endpoint and then removes access to the endpoint resource that has disappeared (step 2108), and the process is complete.

If a GEOL-related event is detected at step 2102, and the event is not associated with an endpoint disappearing from a network as determined at step 2104, then a determination is made as to whether the event is related to a mobile endpoint appearing on a network (step 2110). If so, then a determination is made as to whether the MAC address associated with the endpoint was previously stored within the historical GEOL database (step 2112). If not, then the endpoint is a newly discovered endpoint, and the endpoint can be processed as described above with respect to FIGS. 19A-19B.

If the MAC address associated with the endpoint was previously stored within the historical GEOL database, then a determination is made as to whether the GEOL data from the historical GEOL database is appropriate (step 2114). In other words, the GEOL data in the historical database may not match the GEOL data that would be generated at the current time for the newly appeared endpoint, thereby indicating that the endpoint may have moved within the network in some manner, possibly from a network associated with a first anchor to a network associated with a second anchor. If so, then additional security checks need to be performed.

An event is generated for an administrative user, preferably through a GUI of an administrative application, to notify the administrative user that the endpoint has changed location in some manner (step 2116); the data that is presented to the user can indicate the new and previous locations and the users that were logged into the endpoint while the endpoint was operational at those locations.

A check is then made concerning the access to the endpoint. A determination is made by querying the security subsystem as to whether access to the endpoint is not authorized due to the GEOL data for the endpoint not matching a principal's access rights or an administrative user's access rights (step 2118). If so, then a possible security breach has occurred, and an administrative GUI event is generated to alert an administrator to a possible security breach before any other actual security access violations have occurred (step 2120).

In this manner, previously discovered endpoints can be detected to have moved. For example, this security monitoring operation detects a situation in which a skilled hacker has access to a device that provides access to a network while still determining that the device has moved to a location at which the device should not be used. More particularly, a hacker may steal a laptop computer through which a legitimate user may have access to a network only within specific geographic locations or regions, and there may be a time period in which the system administrators have not yet been notified of the theft in order to configure the security subsystem in the appropriate manner to block the use of the laptop into specific networks. If the hacker has an appropriate means for spoofing the identity of the legitimate user yet also attempts to use the laptop in a geographic location in which the legitimate user would not be authorized, the system can detect this breach of security based solely on geographic location (GEOL) information.

Another particular use of geographic management operations within the network management framework of the present invention includes the distribution of software to the devices within the distributed data processing system based upon the geographic information associated with each device. As explained above, a single network management service provider may manage the networks of multiple customers, each of which may have different types of networks and devices.

With respect to the geographic management functionality described above, the devices within these networks may require software that is specifically configured for a device depending on its geographic location. For example, an ISP may be legally required to provide certain functionality within a given geographic region, either on behalf of its customers or on behalf of law enforcement agencies. After the software that accomplishes the functionality is made available or is modified, the software needs to be pushed to a set of devices within a geographic region.

As another example, a corporate customer whose networks are managed by the network management service provider may have contracted with the service provider to ensure that the software on its desktops are updated with the newest revision of certain software packages. However, the newest revision of a software application may comprise multiple versions that are individually configured for different geographic regions. For instance, a corporate customer may desire that the accounting departments throughout an enterprise have the latest revision of a software application that computes taxes in accordance with the tax laws of a given geographic region, which might require special software modules, tax forms, etc., for each geographic region.

In the prior art, a service provider was not able to manage customer networks based on geographic location. Networks could be constructed or modified such that they were physically contained within a geographic region, thereby physically matching network boundaries with legally or abstractly defined geographic boundaries.

With the present invention, networks can be constructed based on the needs of individual customers and the technical requirements of the networks without regard to the geographic locations of the devices within the networks. The network management framework is then able to configure the networks in a logical manner with respect to geographic location information, after which the network management framework can provide various geographic administrative functionality. Continuing the example from above, a network management service provider can distribute software to the devices within a network based on the geographic location information that has been previously associated with each device by the network management framework; different versions of a software application may be distributed to devices in different geographic regions in accordance with the geographic location information maintained by the network management framework.

While FIGS. 18-21 depict a manner in which a network management framework enables endpoints within a distributed data processing system to be flexibly managed with respect to geographic locations, it would also be particularly useful to provide functionality for managing the distributed data processing system in accordance with geographic boundaries. More particularly, it is useful to be able to perform a network-related action on a group of endpoints that share a common geographic locational attribute, such as performing an action on all endpoints within a common geographic region, e.g., within a state. In addition, it would also be advantageous to be able to perform certain network-related actions with respect to one or more boundaries of the common geographic locational attribute, such as performing certain network-related actions on resources along the boundary of the common geographic region. These types of features would assist the administrators in opening or closing access to resources/devices at the boundaries such that portions of a highly distributed data processing system could be quarantined from other portions of the distributed data processing system. The manner in which the network management framework of the present invention provides these kinds of features are explained below in more detail with respect to the remaining figures.

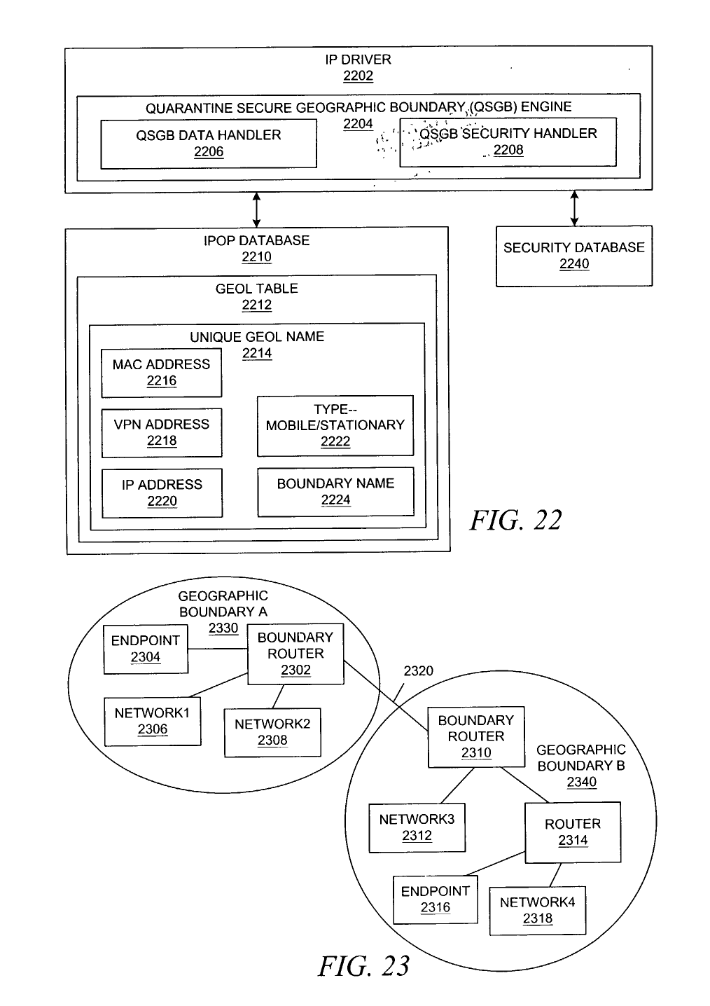

With reference now to FIG. 22, a block diagram depicts components within the network management framework for managing resources within a distributed data processing system in accordance with geographic boundaries. FIG. 22 adds additional components to the components that were shown within FIG. 18.

The DKS network management framework uses a distributed IP driver subsystem to discover and monitor endpoints; IP driver 2202 comprises quarantine secure geographic boundary (QSGB) engine 2204 which includes functionality for generating and managing secure geographic boundaries. For example, QSGB 2204 contains functions for marking or resetting quarantined geographic areas within the IPOP database and for obtaining GEOL data from the IPOP database; QSGB 2204 can also determine whether a system that is defined within the IPOP database is a boundary router. QSGB 2204 also acts as an interface between the gateway/NEL services and the IPOP service for determining whether an AAO can be processed with respect to a quarantined or unquarantined geographic area. QSGB engine 2204 can be compartmentalized into several components for managing quarantinable secure geographic boundaries within an IP driver, as explained below.

QSGB data handler 2206 provides functionality for associating networks, systems, and endpoints with quarantined geographic areas. QSGB data handler can retrieve all geographic boundary routers within a portion of a distributed data processing system or retrieve all endpoints within a geographic boundary. For example, an administrative user may desire to display a topology map showing only router systems that form the geographic boundaries of a portion of a distributed data processing system; the administrative user may be able to specify the customers or scopes with which the topology map should be limited based upon determined boundaries.

QSGB security handler 2208 provides authorization functionality with respect to geographic boundaries, such as creating security attributes for geographic boundaries. QSGB security handler 2208 can determine whether a principal, such as an administrative user, is authorized to access resources on a geographic boundary or within a geographic boundary. Similarly, QSGB security handler 2208 can grant access rights by principals to resources with geographic boundary attributes. As QSGB security handler 2208 interacts with the security subsystem, the security data may be stored within a security-related database, such as security database 2240, which may be maintained by the DSC manager as described above with respect to FIG. 6 and which may be identical to security database 1840 shown in FIG. 18.

GEOL table 2212 within IPOP database 2210 is similar to GEOL table 1816 in FIG. 18; GEOL table 2212 contains unique GEOL names 2214 and data items associated with each GEOL name, such as MAC address 2216, VPN address 2218, IP address 2220, and mobile/stationary flag 2222. In addition, GEOL table 2212 has been expanded to contain boundary name 2224 with which GEOL name 2214 can be associated.

With reference now to FIG. 23, a block diagram depicts a simple QSGB topology map. Router 2302 supports a portion of a distributed data processing system in which only endpoint 2304, network 2306, and network 2308 are shown; other subnetworks, routers, systems, and endpoints may be connected to the entities that are shown. Router 2310 supports a portion of a distributed data processing system in which only network 2312, router 2314, endpoint 2316, and network 2318 are shown; other subnetworks, routers, systems, and endpoints may be connected to the entities that are shown.

FIG. 23 illustrates that the entities connected to router 2302 and the entities connected to router 2310 can interconnect only through communication link 2320. In other words, communication link 2320 between routers 2302 and 2310 is a critical connection that forms an inherent control point for all data traffic between the two portions of the distributed data processing network. From a certain perspective, routers 2302 and 2310 exist as an interface between internal endpoints and external endpoints with respect to a portion of the distributed data processing system. Hence, routers 2302 and 2310 can be designated as boundary routers; all entities connected to boundary router 2302 lie within geographic boundary 2330, and all entities connected to boundary router 2310 lie within geographic boundary 2340.

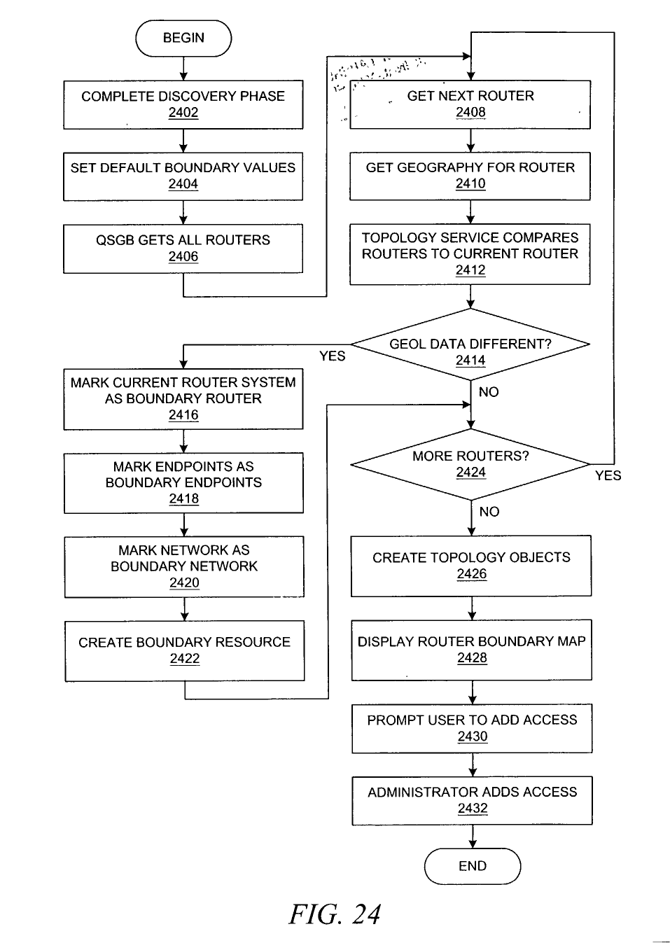

With reference to FIG. 24, a flowchart depicts a process through which geographic boundaries can be configured. The process begins after a discovery phase has been completed and the IPOP database has been populated with the geographic locations of each object (step 2402), as may occur through the process shown in FIG. 19. After the discovery process has found all of the network-related objects in the distributed data processing system, the objects within the IPOP database are associated with default values that indicate that the objects are not boundary objects (step 2404). The QSGB engine then determines which objects are boundary objects.

The QSGB engine obtains or generates a list of all routers in the IPOP database (step 2406); any system that exists at the edge of a network and interfaces with another network must be a router. The QSGB engine then begins a loop to process each router object (step 2408). A call is made to get the geographical location of the router system that is currently being processed (step 2410), and the topology service is asked to compare the GEOL data of all of the endpoints that exist in the current router (step 2412); for example, the router may have multiple NICs that connect to multiple networks, and each NIC would be identified as a unique endpoint, similar to that shown in FIG. 15.

A determination is then made as to whether the geographical location is different for any of the endpoints (step 2414). For example, one endpoint may have been configured with a first network as existing within a first geographical region, while a second endpoint may have been configured with a second network as existing within a second geographical region. If it is found that two of the endpoints are associated with different geographical entities, then the router that is currently being processed is marked within the IPOP database as a boundary router (step 2416). In addition, all endpoints within the current boundary router are marked within the IPOP database as a boundary endpoint (step 2418), and any network or subnet connected to the current boundary router is marked within the IPOP database as a boundary network (step 2420). The QSGB engine then creates a boundary resource name in the security database (step 2422), which may be easily performed in a unique manner by combining the anchor names or the unique GEOL names of two or more networks that are connected to the boundary router. A determination is made as to whether there are more routers to be processed (step 2424), and if so, then the process branches back to step 2408 to process another router.

After all of the routers have been processed, the IP mapper then creates topology objects for a topology map showing a view of the logical boundaries that are formed by the boundary routers (step 2426). The topology service then displays the router boundary map within an administrative GUI application (step 2428). The QSGB then informs an administrative user to add principals and grant access privileges based on the determined boundary information (step 2430), and the administrative user then grants the desired access privileges (step 2432). The process of configuring the geographic boundaries is then complete.

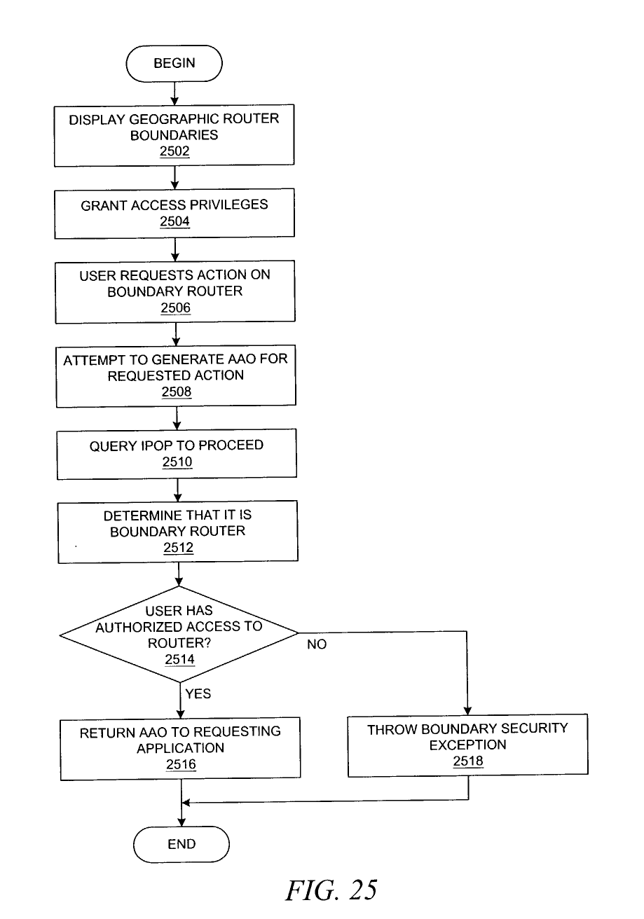

With reference now to FIG. 25, a flowchart depicts a process for configuring and using security access rights to boundary objects. FIG. 25 shows an example of the manner in which access privileges can be assigned (also shown in steps 2428-2432 in FIG. 24) and then used.

An administrative GUI application displays geographical router boundaries of the entire installation based on the derived boundary resources (step 2502). In a preferred embodiment, an administrative user with appropriate security privileges then grants access privileges to a particular boundary resource for a particular principal by performing a GUI operation on both the desired principal and the desired geographic boundary resource (step 2504). This provides access to the boundary but not all objects within a geographic region on either side of the geographic boundary. The administrative user can perform this action on as many principals as desired.

At some later point in time, a principal with boundary access decides to perform a specific action (through an administrative GUI application) on a router that lies on a determined boundary (step 2506), such as pinging a boundary router that forms part of the boundary resource. An attempt is made to generate an AAO for the desired action (step 2508), and the AAO queries the IPOP service to determine whether the action should be performed (step 2510). The IPOP service determines that the router is a boundary router (step 2512), so the IPOP service (in conjunction with the security subsystem) checks whether the administrative user has access to or is authorized for the action on the boundary resource (step 2514). If the user is authorized, then the AAO is returned to the administrative GUI application (step 2516) so that the network-related action can be performed, but if the user is not authorized, then a boundary security exception can be thrown (step 2518). In this manner, resources along a logical, geographic boundary can be treated differently than other resources within the distributed data processing system, thereby restricting the principals that have authorized access to these resources.

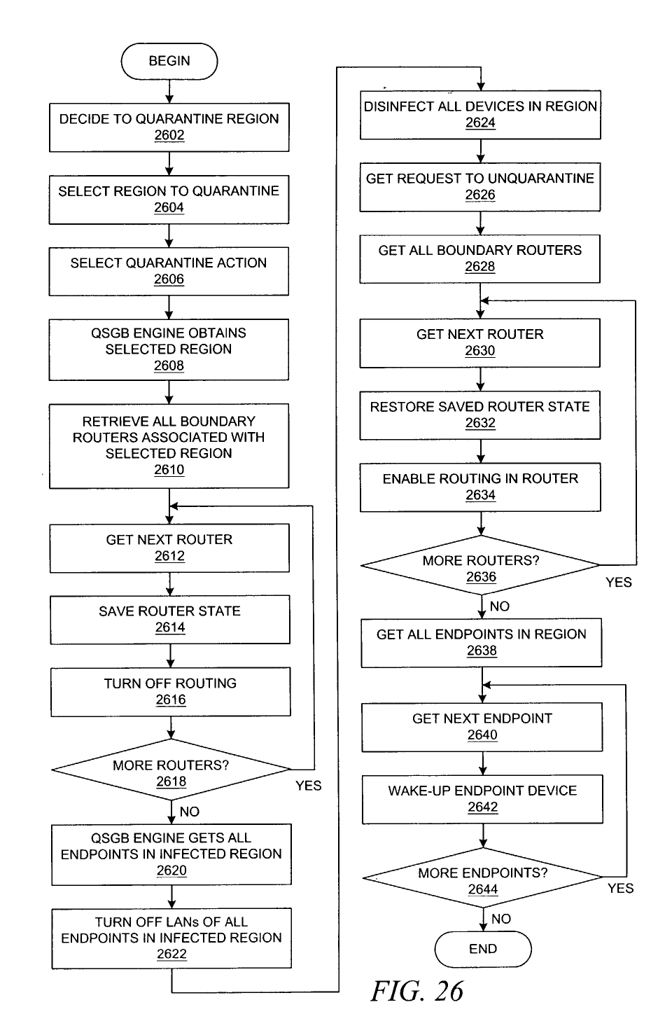

With reference now to FIGS. 26A-26B, a pair of flowcharts depict a process for quarantining devices within secure geographic boundaries. The secure geographic boundary resources that are determined in the process shown in FIG. 24 can be used in many different processes, and the quarantine process shown in FIGS. 26A-26B is merely one of those processes.

The process begins with an administrative user deciding to quarantine a geographic region because a virus has been detected within the region (step 2602). The administrative user chooses the region to quarantine using an administrative GUI application that displays a topology map showing the geographic router boundary resources for various portions of the distributed data processing system (step 2604) and then chooses a quarantine action (step 2606), and the QSGB engine obtains the selected region (step 2608).

The QSGB engine then retrieves all boundary router systems associated with the boundary resource from the IPOP database (step 2610) and begins a loop through the retrieved router systems (step 2612).

For the router currently being processed, the QSGB engine saves the state of the router, including its routing tables (step 2614). The QSGB engine then turns off all routing capabilities in the router in an appropriate manner that may vary depending on the type of router (step 2616), thereby isolating the endpoints in one region from the endpoints in another region. A determination is then made as to whether there are more boundary routers (step 2618), and if so, then the process branches back to step 2612.

The QSGB engine then obtains all of the endpoints within the infected boundary region (step 2620), and the QSGB engine shuts down the networks of all of the endpoints (step 2622), which can be done by issuing a turn-off-LAN command to the network, by instructing the LAN to enter a power-saving mode, or by some other appropriate means.

After the networks within the boundary have been shut down, then the network administrators can find and disinfect all devices within the affected boundary region (step 2624), after which the networks must be unquarantined. An administrative GUI application displays the quarantined region and provides an option to an administrative user to unquarantine the region, and the user requests to unquarantine the region (step 2626).

The QSGB engine retrieves all boundary router systems associated with the boundary resource from the IPOP database (step 2628) and begins a loop through the retrieved router systems (step 2630).

For the router currently being processed, the QSGB engine restores the saved state of the router (step 2632) and enables all of the routing capabilities in the router in the appropriate manner (step 2634), thereby allowing all endpoints in one region to connect to the endpoints in another region. A determination is then made as to whether there are more boundary routers (step 2636), and if so, then the process branches back to step 2630.

The QSGB engine then obtains all of the endpoints within the disinfected boundary region (step 2638), and begins to loop through the endpoints (step 2640). In a preferred embodiment, the QSGB engine re-enables an endpoint in the following manner. The MAC address of the current endpoint is obtained, and the gateway to the endpoint is determined; a wake-on-LAN command is then performed from the gateway to the current endpoint in an attempt to wake-up the network card comprising the endpoint object (step 2642). A determination is then made as to whether there are more endpoints to be processed (step 2644), and if so, then the process branches back to step 2640. Otherwise, the quarantine process is complete.

The advantages of the present invention should be apparent in view of the detailed description of the invention that is provided above. A network management framework flexibly manages multiple customers within a highly distributed system. The network management system is able to provide security while allowing for dynamic changes in location of devices. A geographic location identifier is automatically generated for an endpoint based on the endpoint's MAC address and its relation to a router within its network, thereby uniquely identifying the endpoint using the endpoint's hardware MAC address in conjunction with its geographic location. Network-related actions can be performed on resources with common geographic locations. Security attributes can automatically be associated with the endpoint based on the endpoint's current geographic location, and administrative GUI notification events occur only in response to potential security breaches and not merely in response to a change in geographic location of an endpoint. The present invention effectively introduces the ability to implement security-related commands such that actions can be authorized with respect to geographic locations.

For example, an IT administrator can reconfigure a user's security privileges based on the location of a mobile device. A user can travel with a mobile device, and the mobile device will be able to access various networks in certain geographical regions without further configuration, whereas attempting to use the mobile device in another geographical region will cause a security exception that is based on the identity of the user, the identity of the mobile device, and the location of attempted use.

In addition, secure geographic boundary resources can also be generated in order to enforce security functions along boundaries or within boundaries. This is particularly advantageous because boundary routers are the first points of contact when an attack is launched by an intruder. With the present invention, the boundaries can be controlled as a separate resource, thereby allowing an administrator to shut out potential intruders. If a virus does penetrate a distributed data processing installation, the network management framework is able to quarantine geographic regions to prevent the spread of the virus to other regions of the installation.

Moreover, boundaries can be clearly defined and automatically generated in a flexible manner by deriving the geographic location information for the boundaries from physical networks or by determining dynamic client-server relationships, wherein prior art boundaries were limited to the physical locations of firewalls, which do not convey any geographic usefulness.

It is important to note that while the present invention has been described in the context of a fully functioning data processing system, those of ordinary skill in the art will appreciate that the processes of the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for management of a distributed data processing system, the method comprising:
configuring geographic location information for resources within the distributed data processing system;
identifying router systems within the distributed data processing system;
determining a set of router systems that are closest to a geographic boundary; and
generating a geographic router boundary resource for the set of router systems.

2. The method of claim 1 further comprising:
associating two or more geographic router boundary resources to create a secure boundary between two or more geographic regions.

3. The method of claim 1 further comprising:
configuring user security parameters for controlling access to the geographic router boundary resource.

4. The method of claim 1 further comprising:
authorizing user access to the geographic router boundary resource based on a user security parameter corresponding to the geographic location information.

5. The method of claim 1 further comprising:
authorizing user access to resources within a geographic region as indicated by the geographic router boundary resource based on a user security parameter corresponding to the geographic location information.

6. The method of claim 1 further comprising:
quarantining a set of devices within a geographic region as indicated by the geographic router boundary resource.

7. The method of claim 6 further comprising:
unquarantining a set of devices within a geographic region.

8. The method of claim 1 further comprising:
disinfecting a set of devices within a geographic region as indicated by the geographic router boundary resource.

9. The method of claim 1 further comprising:
dynamically discovering endpoints, systems, and networks within the distributed data processing system;
correspondingly representing endpoints, systems, and networks within the distributed data processing system as a set of endpoint objects, system objects, and network objects; and
logically organizing the endpoint objects, system objects, and network objects within a set of scopes, wherein each endpoint object, each system object, and each network object is uniquely assigned to a scope such that scopes do not logically overlap.

10. The method of claim 1 further comprising:
representing the distributed data processing system as a set of scopes, wherein a scope comprises a logical organization of network-related objects;
associating each scope with a management customer, wherein each scope is uniquely assigned to a management customer, wherein each scope is uniquely associated with a set of configuration parameters for managing each scope;
managing the distributed data processing system as a set of logical networks, wherein a logical network comprises a set of scopes, and wherein each logical network is uniquely assigned to a management customer; and
allowing an administrative user to dynamically reconfigure logical networks within the distributed data processing system.

11. An apparatus for management of a distributed data processing system, the apparatus comprising:
means for configuring geographic location information for resources within the distributed data processing system;
means for identifying router systems within the distributed data processing system;
means for determining a set of router systems that are closest to a geographic boundary; and
means for generating a geographic router boundary resource for the set of router systems.

12. The apparatus of claim 11 further comprising:
means for associating two or more geographic router boundary resources to create a secure boundary between two or more geographic regions.

13. The apparatus of claim 11 further comprising:
means for configuring user security parameters for controlling access to the geographic router boundary resource.

14. The apparatus of claim 11 further comprising:
means for authorizing user access to the geographic router boundary resource based on a user security parameter corresponding to the geographic location information.

15. The apparatus of claim 11 further comprising:
means for authorizing user access to resources within a geographic region as indicated by the geographic router boundary resource based on a user security parameter corresponding to the geographic location information.

16. The apparatus of claim 11 further comprising:
means for quarantining a set of devices within a geographic region as indicated by the geographic router boundary resource.

17. The apparatus of claim 16 further comprising:
means for unquarantining a set of devices within a geographic region.

18. The apparatus of claim 11 further comprising:
means for disinfecting a set of devices within a geographic region as indicated by the geographic router boundary resource.

19. The apparatus of claim 11 further comprising:
means for dynamically discovering endpoints, systems, and networks within the distributed data processing system;
means for correspondingly representing endpoints, systems, and networks within the distributed data processing system as a set of endpoint objects, system objects, and network objects; and
means for logically organizing the endpoint objects, system objects, and network objects within a set of scopes, wherein each endpoint object, each system object, and each network object is uniquely assigned to a scope such that scopes do not logically overlap.

20. The apparatus of claim 11 further comprising:
means for representing the distributed data processing system as a set of scopes, wherein a scope comprises a logical organization of network-related objects;
means for associating each scope with a management customer, wherein each scope is uniquely assigned to a management customer, wherein each scope is uniquely associated with a set of configuration parameters for managing each scope;
means for managing the distributed data processing system as a set of logical networks, wherein a logical network comprises a set of scopes, and wherein each logical network is uniquely assigned to a management customer; and
means for allowing an administrative user to dynamically reconfigure logical networks within the distributed data processing system.

21. A computer program product in a computer readable medium for use in managing a distributed data processing system, the computer program product comprising:
instructions for configuring geographic location information for resources within the distributed data processing system;
instructions for identifying router systems within the distributed data processing system;
instructions for determining a set of router systems that are closest to a geographic boundary; and
instructions for generating a geographic router boundary resource for the set of router systems.

22. The computer program product of claim 21 further comprising:
instructions for associating two or more geographic router boundary resources to create a secure boundary between two or more geographic regions.

23. The computer program product of claim 21 further comprising:
instructions for configuring user security parameters for controlling access to the geographic router boundary resource.

24. The computer program product of claim 21 further comprising:
instructions for authorizing user access to the geographic router boundary resource based on a user security parameter corresponding to the geographic location information.

25. The computer program product of claim 21 further comprising:
instructions for authorizing user access to resources within a geographic region as indicated by the geographic router boundary resource based on a user security parameter corresponding to the geographic location information.

26. The computer program product of claim 21 further comprising:
instructions for quarantining a set of devices within a geographic region as indicated by the geographic router boundary resource.

27. The computer program product of claim 26 further comprising:
instructions for unquarantining a set of devices within a geographic region.

28. The computer program product of claim 21 further comprising:
instructions for disinfecting a set of devices within a geographic region as indicated by the geographic router boundary resource.
